(19) United States
(12) Patent Application Publication
(10) Pub. No.: US 2008/0190849 A1
(43) Pub. Date: Aug. 14, 2008

(54) DEPTH EXPOSED MEMBRANE FOR WATER EXTRACTION

(75) Inventor: Diem Xuan Vuong, San Clemente, CA (US)

Correspondence Address: KNOBBE MARTENS OLSON & BEAR LLP, 2040 MAIN STREET, FOURTEENTH FLOOR, IRVINE, CA, 92614, US

(73) Assignee: DXV Water Technologies, LLC, Tustin, CA (US)

(21) Appl. No.: 12/030,060

(22) Filed: Feb. 12, 2008

Related U.S. Application Data
(60) Provisional application No. 60/889,839, filed on Feb. 14, 2007.
(60) Provisional application No. 60/914,690, filed on Apr. 27, 2007.

(51) Int. Cl. B01D 61/02; C02F 103/08; B01D 61/08; E04B 1/12

(52) U.S. Cl. 210/652; 210/170.11; 264/31

(57) ABSTRACT

A DEMWAX™ water treatment system includes membrane modules and a collection channel. The membrane modules are submerged at depth and tethered to one or more anchors on the ocean floor. A breathing tube extends between the collection channel and a buoy floating on the surface of the ocean to expose the collection channel to atmospheric pressure. A pump pumps the permeate from the collection channel to shore through a permeate pipe. One or more permeate storage tanks can optionally be disposed within the system, for example, as part of or extending from the collection channel, to provide extra storage.

### CROSS-REFERENCE TO RELATED APPLICATIONS

This application claims the benefit under 35 U.S.C. §119(e) of U.S. Provisional Application No. 60/889,839, filed Feb. 14, 2007, and U.S. Provisional Application No. 60/914,690, filed Apr. 27, 2007. The disclosures of the above-referenced applications are hereby expressly incorporated by reference in their entireties.

### FIELD OF THE INVENTION

Systems and methods for the desalination of seawater and the purification of surface and groundwater are provided. The systems utilize the hydrostatic pressure of a natural or induced water column to filter water through a reverse osmosis, nanofiltration or other membrane, whereby a certain desired water quality or potable water is obtained.

### BACKGROUND OF THE INVENTION

More than 97% of water on earth is seawater; three fourths of the remaining water is locked in glacier ice; and less than 1% is in aquifers, lakes and rivers that can be used for agriculture, industrial, sanitary and human consumption. As water in aquifers, lakes and rivers is a renewable resource, this small fraction of the Earth's water is continually re-used. It is the rate of this reuse that has stressed conventional water resources.

In the last century, these water sources became stressed as growing population and pollution limited the availability of easy-to-access freshwater. Recently localized water shortages required the development of desalination plants which make potable water from salty ocean water. The conventional desalination process includes three major steps: pre-treatment; desalination; and post-treatment. In the pre-treatment step, seawater is brought from the ocean to the site of desalination, and then conditioned according to the desalination process to be employed. Water is typically taken from shallow, near-shore areas that contain suspended (e.g., organic or inorganic) material that must be filtered out prior to the desalting process. In the desalination step, a method such as Multistage Flash Distillation (MSF), Multi-effect Distillation (MED), Electro Dialysis (ED), or Reverse Osmosis (RO) is employed to remove salts from the water. The desalination processes typically require substantial amounts of energy in various forms (e.g., mechanical, electrical, etc.), and the disposal of the concentrated brine generated by the process can be a significant environmental concern. In the post-treatment step, product water of the desalination process is conditioned according to its ultimate use.

Multistage flash or multi-effect distillation was the process of choice for the desalination industry for many years, but since the 1990s, improvements in membrane technology and increases in energy costs have made reverse osmosis the clear leader for new capacity.

Reverse Osmosis is a membrane process that acts as a molecular filter to remove 95 to 99% of dissolved salts and inorganic molecules, as well as organic molecules. Osmosis is the natural process which occurs when water or another solvent spontaneously flows from a less-concentrated solution, through a semi-permeable membrane, and into a more concentrated solution. In Reverse Osmosis the natural osmotic forces are overcome by applying an external pressure to the concentrated solution (feed). Thus the flow of water is reversed and desalinated water (permeate) is removed from the feed solution, leaving a more concentrated salt solution (brine). Product water quality can be further improved by adding a second pass of membranes, whereby product water from the first pass is fed to the second pass. In a reverse osmosis process as is typically commercially employed, pretreated seawater is pressurized to between 850 and 1,200 pounds per square inch (psi) (5,861 to 8,274 kPa) in a vessel housing, e.g., a spiral-wound reverse osmosis membrane. Seawater contacts a first surface of the membrane, and through application of pressure, potable water penetrates the membrane and is collected at the opposite side. The concentrated brine generated in the process, having a salt concentration up to about twice that of seawater, is disposed back into the ocean.

### SUMMARY OF THE INVENTION

A highly efficient and innovative process for desalination of seawater and the purification of surface and groundwater is provided. The process uses the hydrostatic pressure of a body of water to drive a reverse osmosis process to remove, e.g., dissolved salts or a filtering process in fresh water bodies to screen out unwanted constituents such as viruses and bacteria. The process is advantageous in its elimination of systems that would be otherwise necessary in a conventional desalination plant or in a conventional water treatment plant, in that it allows efficient use of hydrostatic pressure to facilitate reverse osmosis or other filtration processes. In preferred embodiments, a Depth Exposed Membrane for Water Extraction (DEMWAX™) module is provided that can be suspended from a floating platform, tethered to the bottom, or otherwise positioned at a depth wherein the pressure is sufficient to produce potable water or water of reduced dissolved salts content from seawater via reverse osmosis. In other preferred embodiments, a DEMWAX™ module can be provided with nanofiltration membranes and used to screen contaminants from surface or ground water.

Accordingly, in a first aspect a filtration system is provided, the system comprising a membrane module configured to be submerged in a body of water at a submerged depth, the membrane module comprising at least one membrane cartridge, the membrane cartridge comprising at least one membrane element, the membrane element having a first side and a second side, wherein the first side of the membrane element is exposed to the water to be filtered at a pressure characteristic of the submerged depth; a collector passageway configured to be submerged in the body of water, wherein at least a portion of the collector passageway is in fluid communication with the second side of the membrane element where filtered water is collected; and a breathing passageway extending from the collector passageway to a surface of the body of water and configured to expose an interior of the collector passageway to a pressure characteristic of atmospheric pressure at the surface of the body of water or at an elevation higher than the surface of the body of water, wherein a differential between the pressure characteristic of the submerged depth and the pressure characteristic of atmospheric pressure at the surface of the body of water or at an elevation higher than the surface of the body of water causes permeate to flow from the first side of the membrane element to the second side of the membrane element.

In an embodiment of the first aspect, the membrane element comprises two membrane layers spaced apart by at least one permeate spacer.

In an embodiment of the first aspect, the membrane element is substantially planar.

In an embodiment of the first aspect, the membrane cartridge comprises at least two membrane elements.

In an embodiment of the first aspect, the water treatment system comprises a plurality of membrane elements, wherein each membrane element is spaced apart from an adjacent membrane element by at least about 1 mm.

In an embodiment of the first aspect, the water treatment system comprises a plurality of membrane elements, wherein each membrane element is spaced apart from an adjacent membrane element by at least about 2 mm.

In an embodiment of the first aspect, the water treatment system comprises a plurality of membrane elements, wherein each membrane element is spaced apart from an adjacent membrane element by from about 2 mm to about 8 mm.

In an embodiment of the first aspect, the water treatment system comprises a plurality of membrane elements, wherein each membrane element is spaced apart from an adjacent membrane element by about 6 mm.

In an embodiment of the first aspect, the membrane element comprises two flat sheet membranes in a parallel configuration, the membrane element further comprising at least one collector spacer situated between two flat sheet membranes, wherein the collector spacer is configured to separate the two flat sheet membranes from each other.

In an embodiment of the first aspect, the membrane module comprises a plurality of the membrane cartridges.

In an embodiment of the first aspect, the membrane element comprises at least one nanofiltration membrane. The membrane module can be configured to be submerged to a depth of at least about 6 meters, or to a depth of at least about 8 meters, or to a depth of at least about 10 meters, or to a depth of from about 12 meters to about 18 meters, or to a depth of at least about 30 meters, or to a depth of at least about 60 meters, or to a depth of about 60 meters, or to a depth of from about 60 meters to about 244 meters, or to a depth of from about 122 meters to about 152 meters, or to a depth of from about 152 meters to about 183 meters.

In an embodiment of the first aspect, the membrane element comprises at least one reverse osmosis membrane. The membrane module can be configured to be submerged to a depth of at least about 190 meters, or to a depth of at least about 244 meters, or to a depth of from about 259 meters to about 274 meters.

In an embodiment of the first aspect, the membrane element comprises at least one ultrafiltration membrane. The membrane module can be configured to be submerged to a depth of at least about 6 meters, or to a depth of at least about 8 meters, or to a depth of at least about 10 meters, or to a depth of from about 12 meters to about 18 meters, or to a depth of at least about 22 meters, or to a depth of from about 22 meters to about 60 meters.

In an embodiment of the first aspect, the membrane element comprises at least one microfiltration membrane. The membrane module can configured to be submerged to a depth of at least about 6 meters, or to a depth of at least about 8 meters, or to a depth of at least about 10 meters, or to a depth of from about 12 meters to about 18 meters.

In an embodiment of the first aspect, the membrane module is configured to be submerged to a depth of at least about 7 meters, and is further configured to substantially avoid entrainment of aquatic life as permeate passes from the first side of the membrane element to the second side of the membrane element.

In an embodiment of the first aspect, the differential between the pressure characteristic of the submerged depth and the pressure characteristic of atmospheric pressure at the surface of the body of water provides substantially all of the force driving the filtration process, in the absence of a mechanical device to increase the pressure to which the first side of the membrane is exposed, and in the absence of a mechanical device to reduce the pressure to which the second side of the membrane is exposed.

In a second aspect, a water treatment system is provided comprising at least one membrane configured to be submerged to a depth in a body of water to be treated, the water having a first pressure at the submerged depth, the membrane having a concentrate side and a permeate side; a collector in fluid communication with the permeate side of the membrane; and a passageway configured to expose an interior of the collector to a second pressure which is lower than the first pressure, wherein exposing the concentrate side of the membrane to the first pressure drives a filtration process in which permeate moves across the membrane from the concentrate side to the permeate side.

In an embodiment of the second aspect, the second pressure is characteristic of atmospheric pressure at the surface of the body of water.

In an embodiment of the second aspect, the passageway extends from the collector to at least the surface of the body of water.

In an embodiment of the second aspect, the collector is the passageway.

In a third aspect, a water treatment system is provided comprising means for screening out at least one constituent from a source water to produce a product water, the screening means having a source water side and a product water side, wherein the source water side is configured to be exposed to a hydrostatic pressure of the source water; and means for collecting the product water, wherein the collecting means is configured to be exposed to a pressure lower than the hydrostatic pressure.

In an embodiment of the third aspect, the lower pressure is characteristic of atmospheric pressure at the surface of the source water.

In a fourth aspect, a water treatment system is provided comprising means for filtering a source water to produce a product water, the filtering means having a source water side and a product water side; and means for taking advantage of ambient pressure conditions in the source water and above the source water to create a pressure differential between the source water side and the product water side sufficient to induce permeate to cross from the source water side to the product water side.

In a fifth aspect, a filtration system is provided for producing product water from feed water, the system comprising at least one reverse osmosis membrane, wherein the membrane is configured to permit passage of water therethrough while restricting passage therethrough of one or more ions dissolved in the feed water, wherein the membrane is configured to be submerged at a depth in a body of feed water containing the ions dissolved therein, wherein the depth is at least about 141 meters, wherein a first side of the membrane is configured to be exposed to the feed water at a pressure characteristic of the submerged depth, and wherein a collector on a second side of the membrane is configured to be exposed to a pressure characteristic of atmospheric pressure at sea level, whereby, in use, a pressure differential across the membrane drives a reverse osmosis filtration process such that a permeate of a reduced dissolved ion concentration is obtained on the second side of the membrane, wherein the membrane is situated such that, in use, at least one of gravity and current effectively removes a higher density concentrate away from the membrane.

In an embodiment of the fifth aspect, the system is configured to be submerged in a body of seawater to a depth of from about 113 meters to about 307 meters, wherein the seawater has a salinity of from about 20,000 to about 42,000 ppm.

In an embodiment of the fifth aspect, the system is configured to be submerged in a body of seawater to a depth of from about 247 meters to about 274 meters, wherein the seawater has a salinity of from about 33,000 to about 38,000 ppm.

In an embodiment of the fifth aspect, the system comprises a plurality of membranes, wherein each membrane is spaced apart from an adjacent membrane by at least about 1 mm.

In an embodiment of the fifth aspect, the system comprises a plurality of membranes, wherein each membrane is spaced apart from an adjacent membrane by at least about 2 mm.

In an embodiment of the fifth aspect, the system comprises a plurality of membranes, wherein each membrane is spaced apart from an adjacent membrane from about 2 mm to about 8 mm.

In an embodiment of the fifth aspect, the system comprises a plurality of membranes, wherein each membrane is spaced apart from an adjacent membrane about 6 mm.

In an embodiment of the fifth aspect, the collector is exposed to a pressure characteristic of atmospheric pressure at sea level via a passageway.

In an embodiment of the fifth aspect, the passageway is a breathing tube. The breathing tube can extend from about the submerged depth to at least a surface of the body of feed water.

In an embodiment of the fifth aspect, the passageway comprises at least one space between two membranes.

In an embodiment of the fifth aspect, the collector is a holding tank in fluid communication with air at a surface of the body of feed water.

In an embodiment of the fifth aspect, the system further comprises a pump configured to transfer permeate from a first location to a second location.

In an embodiment of the fifth aspect, the system further comprises a permeate storage tank at least partially submerged in the body of feed water.

In an embodiment of the fifth aspect, the permeate storage tank is at least partially submerged and comprises a flexible material that can accommodate filling and discharging of permeate.

In an embodiment of the fifth aspect, the system further comprises at least one membrane module, wherein the membrane module comprises one or more paired flat sheet membranes sealed at edges to prevent ingress of feed water, wherein outer surfaces of the paired flat sheet membranes are configured to be exposed to feed water, and wherein, in use, permeate can be withdrawn from between the paired membrane sheets through a permeate collection module.

In an embodiment of the fifth aspect, the system further comprises an offshore platform from which the membrane module is suspended.

In an embodiment of the fifth aspect, the system further comprises a channel configured to transport potable water to shore.

In a sixth aspect, a filtration system for producing product water from feed water is provided, the system comprising at least one nanofiltration membrane, wherein the membranes is configured to permit passage of water therethrough while restricting passage therethrough of at least one constituent, wherein the membrane is configured to be submerged at a depth in a body of feed water containing the constituents, wherein the depth is at least about 6 meters, wherein a first side of the membrane is configured to be exposed to the feed water at a pressure characteristic of the submerged depth, and wherein a collector on a second side of each of the membrane is configured to be exposed to a pressure characteristic of atmospheric pressure at a surface of the body of feed water, whereby, in use, a pressure differential across the membrane drives a filtration process such that a permeate having a reduced concentration of the constituent is obtained on the second side of the membrane, wherein, the membrane is situated so as to prevent surface tension from inhibiting substantially free flow of feed water across the first side of the membrane.

In an embodiment of the sixth aspect, the depth is at least about 8 meters.

In an embodiment of the sixth aspect, the depth is at least about 10 meters.

In an embodiment of the sixth aspect, the pressure differential between the pressure characteristic of the submerged depth and the pressure characteristic of atmospheric pressure provides substantially all of the force driving the filtration process.

In an embodiment of the sixth aspect, the filtration process occurs without the influence of a vacuum pump.

In an embodiment of the sixth aspect, the system further comprises a positive head pump configured to move permeate from the collector to the surface of the body of feed water.

In a seventh aspect, a dual-pass system for desalination of water is provided, the system comprising a first pass filtration system, the first pass filtration system comprising at least one first nanofiltration membrane configured to permit passage of water therethrough while restricting passage of one or more dissolved ions therethrough, wherein the first membrane is configured to be submerged in a body of seawater to a depth of at least about 113 meters, wherein a first side of the first membrane is configured to be exposed to the seawater at a pressure characteristic of the submerged depth, and wherein a second side of the first membrane is configured to be exposed to a pressure characteristic of atmospheric pressure at sea level or an elevation higher than sea level, whereby, in use, a pressure differential across the first membrane drives a filtration process such that a permeate of reduced salinity is obtained on the second side of the first membrane, wherein the first membrane is configured such that, in use, at least one of gravity and current effectively removes a higher density concentrate away from the first membrane; and a second pass filtration system, the second pass filtration system comprising at least one second membrane, wherein the second membrane is a nanofiltration membrane or a reverse osmosis membrane.

In an embodiment of the seventh aspect, a first side of the second membrane is configured to be exposed to the permeate of reduced salinity, and is configured such that, in use, a pressure differential is applied across the second membrane to drive a filtration process such that a permeate of further reduced salinity is obtained on the second side of the second membrane.

In an embodiment of the seventh aspect, the first-pass filtration system is configured to be submerged in a body of seawater to a depth of from about 152 meters to about 213 meters, the seawater having a salinity of from about 33,000 to 38,000 ppm.

In an embodiment of the seventh aspect, the system comprises a plurality of first nanofiltration membranes, wherein each of the first nanofiltration membranes is spaced apart from an adjacent membrane by about 1 mm or more.

In an embodiment of the seventh aspect, the system comprises a plurality of first nanofiltration membranes, wherein each of the first nanofiltration membranes is spaced apart from an adjacent membrane by about 2 mm or more.

In an embodiment of the seventh aspect, the system comprises a plurality of first nanofiltration membranes, wherein each of the first nanofiltration membranes is spaced apart from an adjacent membrane by from about 2 mm to about 8 mm.

In an eighth aspect, a method for treating water is provided, the method comprising: submerging a membrane module in a source water to a submerged depth, the membrane module comprising at least one membrane unit, the membrane unit having a first side and a second side, wherein at least a portion of the second side is in fluid communication with a collector channel, and wherein the first side is exposed to the source water at a first pressure, wherein the first pressure is characteristic of the submerged depth; exposing the collector channel to a second pressure, wherein the second pressure is sufficient to induce permeate to cross from the first side to the second side; and collecting permeate in the collector system.

In an embodiment of the eighth aspect, the second pressure is characteristic of atmospheric pressure at a surface of the source water or at an elevation higher than the surface of the source water.

In an embodiment of the eighth aspect, permeate is induced to cross from the first side to the second side without the use of a vacuum pump.

In an embodiment of the eighth aspect, the membrane unit comprises at least one nanofiltration membrane. The membrane module can be submerged to a depth of at least about 6 meters, or to a depth of at least about 8 meters, or to a depth of at least about 10 meters, or to a depth of from about 12 meters to about 18 meters, or to a depth of at least about 30 meters, or to a depth of at least about 60 meters, or to a depth of about 60 meters, or to a depth of from about 60 meters to about 244 meters, or to a depth of from about 122 meters to about 152 meters, or to a depth of from about 152 meters to about 183 meters.

In an embodiment of the eighth aspect, the membrane unit comprises at least one reverse osmosis membrane. The membrane module can submerged to a depth of at least about 190 meters, or to a depth of at least about 244 meters, or to a depth of from about 259 meters to about 274 meters.

In an embodiment of the eighth aspect, the membrane unit comprises at least one ultrafiltration membrane. The membrane module can be submerged to a depth of at least about 6 meters, or to a depth of at least about 8 meters, or to a depth of at least about 10 meters, or to a depth of from about 12 meters to about 18 meters, or to a depth of at least about 22 meters, or to a depth of from about 22 meters to about 60 meters.

In an embodiment of the eighth aspect, the membrane unit comprises at least one microfiltration membrane. The membrane module can submerged to a depth of at least about 6 meters, or to a depth of at least about 8 meters, or to a depth of at least about 10 meters, or to a depth of from about 12 meters to about 18 meters.

In an embodiment of the eighth aspect, the membrane module is submerged to a depth of at least about 7 meters, and is further configured to substantially avoid entrainment of aquatic life as permeate passes from the first side of the membrane element to the second side of the membrane element.

In a ninth aspect, a method for treating water is provided, the method comprising exposing at least one membrane situated in a body of water to a hydrostatic pressure characteristic of an immersion depth of the membrane, the membrane having a concentrate side and a permeate side, wherein the permeate side is in fluid communication with a collector; exposing at least a portion of an interior of the collector to a pressure lower than the hydrostatic pressure, whereby permeate passes from the concentrate side to the permeate side of the membrane; and collecting permeate from the collector.

In an embodiment of the ninth aspect, the second pressure is characteristic of atmospheric pressure at a surface of the body of water or at an elevation higher than that of the surface of the water.

In an embodiment of the ninth aspect, the membrane functions as the collector.

In a tenth aspect, a method of treating water is provided, the method comprising submerging means for screening out at least one unwanted constituent from a source water, the screening means defining a source water side and a product water side, wherein the source water side is exposed to a hydrostatic pressure of the source water; exposing the product water side to a low pressure system, the low pressure system having a pressure lower than the hydrostatic pressure, whereby product water passes from the source water side to the product water side; and collecting the product water.

In an eleventh aspect, a method of manufacturing a water treatment module is provided, the method comprising attaching at least one source water spacer to a first membrane unit, the membrane unit comprising two membrane layers spaced apart by a permeate spacer layer, the first membrane unit having a sealed edge portion and an unsealed edge portion; attaching a second membrane unit to the source water spacer; and coupling a collector spacer to the unsealed edge portions of the first membrane unit and the second membrane unit, wherein the collector spacer is configured to form a watertight seal separating a source water side of the first membrane unit and the second membrane unit from a product water side of the first membrane unit and the second membrane unit.

In a twelfth aspect, a method of transporting water from an offshore collection facility to land is provided, the method comprising submerging a collection unit at a first depth in a body of water, wherein at least a portion of the collection unit is exposed to an atmospheric pressure; providing a passageway in fluid communication with the collection unit, the passageway extending from the collection unit to a location on land, wherein the location on land is at an elevation lower than the first depth.

In an embodiment of the twelfth aspect, the collection unit comprises at least one membrane element, each membrane element having a first side and a second side, wherein the first side is exposed to a pressure characteristic of the body of water at the first depth, and wherein the second side is in fluid communication with a portion of the collection unit exposed to atmospheric pressure.

### BRIEF DESCRIPTION OF THE DRAWINGS

FIG. 1 provides a diagram (not to scale) of a DEMWAX™ module tethered to the floor of a body of water.

FIG. 2 provides a diagram (not to scale) of a DEMWAX™ module adapted for use in temporary installations.

FIG. 3 provides a diagram (not to scale) of a DEMWAX™ module suspended from a floating platform.

FIG. 4 provides a diagram (not to scale) of a DEMWAX™ module adapted for use with large-scale applications or for those users desiring more access to the membrane modules.

FIG. 5 provides a plan view (not to scale) of a DEMWAX™ membrane module utilizing vertically aligned membranes in a box configuration.

FIG. 6 depicts the spiral-wound elements of a conventional reverse osmosis membrane module, prior to being rolled.

FIGS. 7A and 7B shows a cutaway view of a reverse osmosis membrane module having twelve layers of membrane wrapped around a permeate tube.

FIG. 8 shows a cross section of a membrane element from a conventional reverse osmosis unit (prior to being rolled).

FIG. 9A shows a perspective view (not to scale) of a membrane cartridge according to an embodiment.

FIGS. 9B through 9F illustrate steps in a process for making a membrane cartridge.

FIG. 10 depicts schematically the process of reverse osmosis filtration and downward motion of generated brine.

FIGS. 11A through 11C schematically depict various systems for transporting water collected offshore to shore.

FIG. 12 shows a basic diagram (not to scale) of a DEMWAX™ membrane cartridge in cross section, illustrating saltwater spacers and shown with the permeate side of the membrane elements in fluid communication with a collection system. The saltwater spacers are plastic ‘balls’ arrayed in a checkerboard pattern and connected with strong plastic fibers. The spacers obviate the need for a lattice box to separate the membranes.

FIG. 13 depicts corrugated woven plastic fibers suitable for use as saltwater or source water spacers.

FIG. 14 shows a basic diagram (not to scale) of a permeate water collector channel for use with the DEMWAX™ system.

FIG. 15A shows a basic diagram (not to scale) of a module with multiple cartridges containing multiple membrane elements and a collector channel for use with the DEMWAX™ system.

FIG. 15B shows a basic diagram (not to scale) of a module with multiple cartridges containing multiple membrane elements and a collector channel for use with the DEMWAX™ system.

FIG. 15C shows a basic diagram (not to scale) of a DEMWAX™ module with multiple cartridges containing multiple membrane elements fluidly connected to a collection system. FIG. 16 shows a side view of a collection frame with the placement of membrane cartridges illustrated in dashed lines.

FIG. 17A shows a cutaway perspective view (not to scale) of a membrane module with a membrane cartridge and a portion of the collection system removed to better illustrate portions of the collection system.

FIG. 17B shows a perspective view (not to scale) of a membrane module with a collection framework supporting four sets of cartridges. FIG. 18 shows a basic diagram (not to scale) depicting a top view of a DEMWAX™ plant, showing submerged membrane modules suspended from an offshore platform.

FIG. 19 shows a basic diagram (not to scale) depicting a top view of submerged DEMWAX™ modules in an array suspended from a platform and arranged in parallel and serial configurations.

FIG. 20 shows a plan view of a plant with multiple arrays of DEMWAX™ modules.

FIG. 21 shows a side view of a buoy array system of DEMWAX™ modules.

FIG. 22 provides a diagram of a DEMWAX™ cartridge adapted for use with groundwater applications.

FIGS. 23A and 23B illustrate a cylindrical DEMWAX™ cartridge.

FIGS. 24A and 24B illustrate a cylindrical DEMWAX™ cartridge.

### DETAILED DESCRIPTION OF THE PREFERRED EMBODIMENT

The following description and examples illustrate preferred embodiments of the present invention in detail. Those of skill in the art will recognize that there are numerous variations and modifications of this invention that are encompassed by its scope. Accordingly, the description of a preferred embodiment should not be deemed to limit the scope of the present invention.

Conventional reverse osmosis desalination plants expose reverse osmosis membranes to high-pressure saltwater. This pressure forces water through the membrane while preventing (or impeding) passage of ions, selected molecules, and particulates therethrough. Desalination processes are typically operated at a high pressure, and thus have a high energy demand. Various desalination systems are described in U.S. Pat. No. 3,060,119 (Carpenter); U.S. Pat. No. 3,456,802 (Cole); U.S. Pat. No. 4,770,775 (Lopez); U.S. Pay. No. 5,229,005 (Fok); U.S. Pat. No. 5,366,635 (Watkins); and U.S. Pat. No. 6,656,352 (Bosley); and U.S. Patent Application No. 2004/0108272 (Bosley); the disclosures of each of which are hereby incorporated by reference in their entireties.

Systems are provided for purifying and/or desalinating water. The systems involve exposure of one or more membranes, such as nanofiltration (NF) or reverse osmosis (RO) membranes, to the hydrostatic pressure of a natural or induced water column, for example, high-pressure water in the depths of the sea. The membrane is submerged to a depth where the pressure is sufficient to overcome the sum of the osmotic pressure of the feed water (or raw water) that exists on the first side of the membrane and the transmembrane pressure loss of the membrane itself. For seawater or other water containing higher amounts of dissolved salts, transmembrane pressure losses are typically much smaller than the osmotic pressure. Thus, in some applications, osmotic pressure is a more significant driver than transmembrane pressure losses in determining the required pressure (and thus, the required depth). In treatment of fresh surface water or water containing lower amounts of dissolved salts, osmotic pressures tend to be lower, and the transmembrane pressure losses become a more significant factor in determining the required pressure (and thus, the required depth). Typically, systems adapted for desalinating seawater require greater pressures, and thus greater depths, than do systems for treating freshwater.

The systems of preferred embodiments utilize membrane modules of various configurations. In a preferred configuration, the membrane module employs a membrane system wherein two parallel membrane sheets are held apart by permeate spacers, and wherein the volume between the membrane sheets is enclosed. Permeate water passes through the membranes and into the enclosed volume, where it is collected. Particularly preferred embodiments employ rigid separators to maintain spacing between the membranes on the low pressure (permeate) side; however, any suitable permeate spacer configuration (e.g., spacers having some degree of flexibility or deformability) can be employed which is capable of maintaining a separation of the two membrane sheets. The spacers can have any suitable shape, form, or structure capable of maintaining a separation between membrane sheets, e.g., square, rectangular, or polygonal cross section (solid or at least partially hollow), circular cross section, I-beams, and the like. Spacers can be employed to maintain a separation between membrane sheets in the space in which permeate is collected (permeate spacers), and spacers can maintain a separation between membrane sheets in the area exposed to raw or untreated water (e.g., raw water spacers). Alternatively, configurations can be employed that do not utilize raw water spacers. Instead, separation is provided by the structure that holds the membranes in place, e.g., the supporting frame. Separation can also be provided by, e.g., a series of spaced expanded plastic media (e.g., spheres), corrugated woven plastic fibers, porous monoliths, nonwoven fibrous sheets, or the like. Similarly, the spacer can be fabricated from any suitable material. Suitable materials can include rigid polymers, ceramics, stainless steel, composites, polymer coated metal, and the like. As discussed above, spacers or other structures providing spacing are employed within the space between the two membrane surfaces where permeate is collected (e.g., permeate spacers), or between membrane surfaces exposed to raw water (e.g., raw water spacers).

Alternatively, one or more spiral-wound membrane units can be employed in a loosely rolled configuration wherein gravity or water currents can move higher density concentrate through the configuration and away from the membrane surfaces. The membrane elements can alternatively be arrayed in various other configurations (planar, spiral, curved, corrugated, etc.) which maximize surface exposure and minimize space requirements. In a preferred configuration, these elements are arrayed vertically, spaced slightly, and are lowered to depth. In seawater applications, the hydrostatic pressure of the ocean forces water through the membrane, and a gathering system collects the treated water and pumps it to the surface, to shore, or to any other desired location. If a spiral-wound configuration is employed, the membranes are preferably spaced farther apart than in a conventional reverse osmosis system, e.g., about 0.25 inches or more (about 6 millimeters or more), and the configuration is preferably in an “open” module (that is, configured to expose the membranes directly to the ambient source water and allow substantially uninhibited flow of source water past the membranes). Such a configuration facilitates the flow of feed water past the membranes, and especially facilitates the ability of gravity to draw down the higher density concentrate generated at the surface of the membrane by the filtration process. While an open configuration is typically preferred, in certain embodiments a configuration other than an open configuration can be desirable.

The systems of preferred embodiments offer the advantage of eliminating the need to pressurize the feed or raw water by lowering the membranes into seawater at depths of from about 194 meters to about 307 meters or more. Conventional land-based reverse osmosis processes typically require tremendous amounts of energy to generate this pressure. Preferably, the depth employed in the systems of preferred embodiments using reverse osmosis membranes is from about 247 meters to about 274 meters, when it is desired to produce potable water from seawater of average salinity (e.g., water from the Pacific Ocean having a salinity of about 35,000 mg/liter); most preferably the depth is about 259 meters. Of course, systems using reverse osmosis membranes can also be deployed at shallower depths. If reduced salinity water (e.g., brackish water suitable for irrigation, industrial cooling use, or the like) is desired, the preferred depth for systems using nanofiltration membranes is from about 113 meters to about 247 meters or more. Preferably, the depth is from about 152 meters to about 213 meters to produce brackish water from seawater of average salinity (e.g., water from the Pacific Ocean having a salinity of about 35,000 ppm or mg/L). Of course, systems using nanofiltration membranes can also be deployed at greater depths than 213 meters; such systems can be deployed at the same depths as those employing reverse osmosis membranes.

The preferred depth can depend on a variety of factors, including but not limited to membrane chemistry, membrane spacing, ambient currents, salinity of the seawater (or dissolved ion content of the feed water), salinity of the permeate (or dissolved ion content of the permeate), and the like. At depth, the seawater in contact with the membranes is naturally at a continual high pressure. Other advantages of the systems of preferred embodiments are that they do not require high pressure pipes, water intake systems, water pre-treatment systems, or brine disposal systems. The systems of preferred embodiments can also be deployed at even shallower depths. For example, embodiments can be deployed in shallow ocean waters for use in desalination pretreatment systems or ocean water intake systems. Having no high-velocity intake, such systems advantageously avoid harming sea life. Selected systems of preferred embodiments are preferably configured such that saltwater does not come into contact with any interior metallic components, dramatically mitigating the corrosive effects of selected dissolved ions that affect conventional reverse osmosis systems. The systems are preferably configured to be employed in the open ocean, thus not requiring significant land area near the shore as in conventional land-based reverse osmosis systems. While it is generally preferred to operate the systems of preferred embodiments at depths of 247 meters to about 274 meters, systems can advantageously be configured for operation at shallower depths. For example, systems including microfiltration, ultrafiltration, or nanofiltration membranes can be positioned in surface waters and reservoirs at much shallower depths and configured to filter out bacteria, viruses, organics, and inorganics from a freshwater source. Most preferably, surface water treatment systems employ nanofiltration membranes. The membranes of such systems can be positioned at a depth of about 6 meters to 61 meters, or at any other appropriate depth, depending upon the total dissolved solids to be removed, the desired intake velocity, and the desired quality of the product water. Systems including microfiltration, ultrafiltration, or reverse osmosis membranes can also be adapted to produce purified water from a contaminated water supply and can be configured for placement in ground wells.

The membrane modules of certain preferred embodiments are employed to separate unwanted constituents from the feed water and transfer the product water thus generated to an underwater collection system including a pump. This collection system can act as a tank holding enough permeate to buffer the variability of membrane production and pump speed. The pumps can be of any suitable form, including submersible pumps, dry well pumps, or the like. The collection system is connected to at least two pipes, tubes, passageways or other flow directing means, one through which permeate water is directed to the surface, shore, or other desire location; and one of which isolates (or protects) the membranes from the pump operation (e.g., a ‘breathing tube’). The pressure surge in the system caused by turning the pump on or off can be relieved by the breathing tube emptying or filling rather than by suddenly increasing or decreasing the pressure differential across the membranes. Without a breathing tube, the stress on the membrane unit due to pump cycling (e.g., for system maintenance) can decrease membrane life or cause other mechanical wear. While it is particularly preferred to employ a breathing tube to expose the permeate holding tank to atmospheric pressure, and thereby allow the flow of permeate water through the membrane when exposed to pressure at depth, other means of applying a reduced pressure to the permeate side of the membranes can also be employed to drive the filtration process. A single breathing tube or multiple breathing tubes can be employed. Likewise, multiple flow directing means can advantageously be employed (e.g., multiple pipes to send permeate water to a single location or to different locations, etc.) The breathing tube(s) are preferably configured to avoid sonic effects observed for extremely rapid flow of air through the breathing tube(s) when the pumps are started or stopped.

Collection systems for use in ocean applications are configured to gather or accumulate the permeate and convey it to the ocean surface or some other desired location (a submerged location, underground or surface storage tanks on shore, or the like). Such collection systems are preferably buoyant and tethered to the ocean floor to avoid the effects of surface storms and visual impact; however, other configurations can also be advantageously employed. For example, a surface platform (floating or fixed) can be situated in the ocean, and the membrane modules can be suspended from it. Ocean currents are preferably taken into account in suspending the module. The current applies a force against the suspended module, displacing it to the side. As in a pendulum, as the module is displaced to the side, it is forced closer to the surface. If currents are relatively constant, the module can be suspended from a line that is longer than the preferred module depth, with the result that the force of the current will push the module to the side and up to the preferred depth. These same considerations apply, in reverse, for buoyant modules which are tethered to the floor of a body of water. Thus, in certain embodiments, the length of the line can be adjusted to compensate for changes in current (e.g., a current sensor can be employed, along with a winch) such that the module is maintained at the preferred depth. Alternatively, the module can be situated at a depth such that current displacement does not result in the module rising above the preferred depth.

The systems of preferred embodiments can employ conventional ocean platform technology. For example, a concrete hulled floating platform can be employed to support a power module for power generation (e.g., a generator, a transformer, etc.), fuel storage, maintenance spares storage, and other infrastructure to run the system. As potable water demand on land is not uniform throughout the day, a continuous production process preferably employs a storage system. When demand is low, as a supplement to onshore storage, the platform can employ a floating tank made of a flexible material, such as HYPERLON™, that expands and contracts as the tank fills and empties. Such storage systems are suspended in the ocean, and thus do not require heavy construction work as is required in onshore water tanks or tanks situated near shore land.

The potable or reduced ion content water generated by the system is preferably transported to shore by taking advantage of the near identical pressures inside and outside of a pipeline. For example, in selected embodiments an underwater floating, flexible pipe made of HYPERLON™ or other suitable materials can be employed. Such pipes are preferably suspended beneath the ocean surface, e.g., at about 100 feet below the surface, or along the ocean floor. The depth of the pipe is preferably such that it will not interfere with any surface traffic. If no surface traffic is present at the system location, then it can be advantageous to employ a pipe at the surface of the ocean. While flexible pipe is advantageously employed, rigid pipe, a cement flow channel, or other tube or passageway configurations can be employed.

Desalination plants often add certain chemicals (e.g., chlorine, fluorine, algaecides, antifoams, biocides, boiler water chemicals, coagulants, corrosion inhibitors, disinfectants, flocculants, neutralizing agents, oxidants, oxygen scavengers, pH conditioners, resin cleaners, scale inhibitors, and the like) to the desalinated water, depending on local regulations. This activity can take place on shore as the water is being delivered to the distribution system or at any other suitable place in the system. DEMWAX™ System

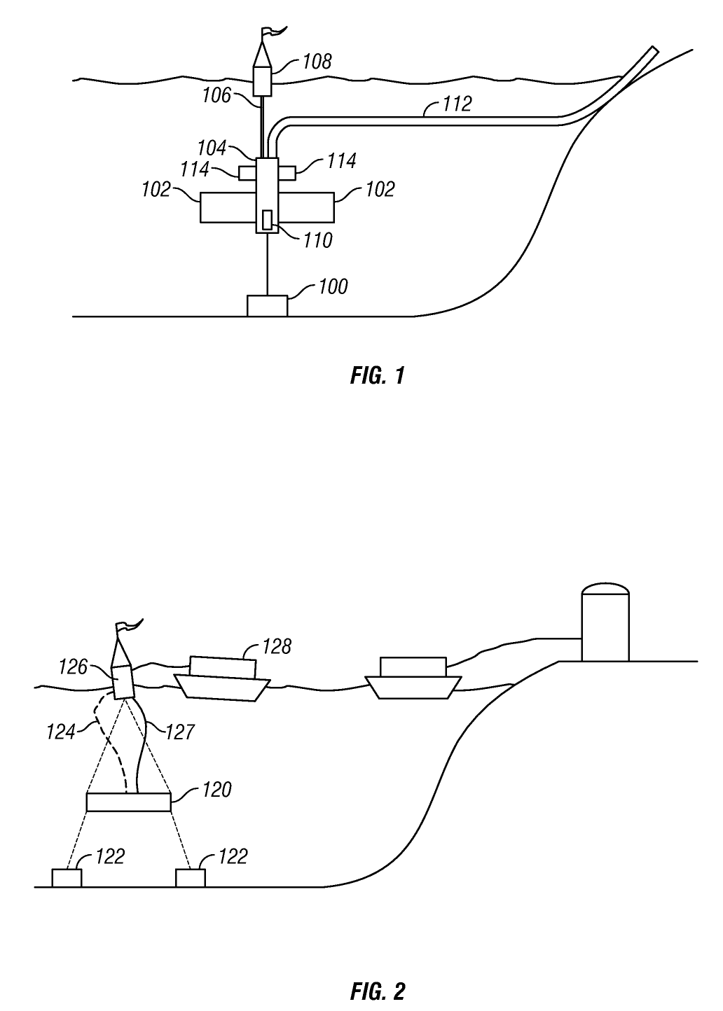

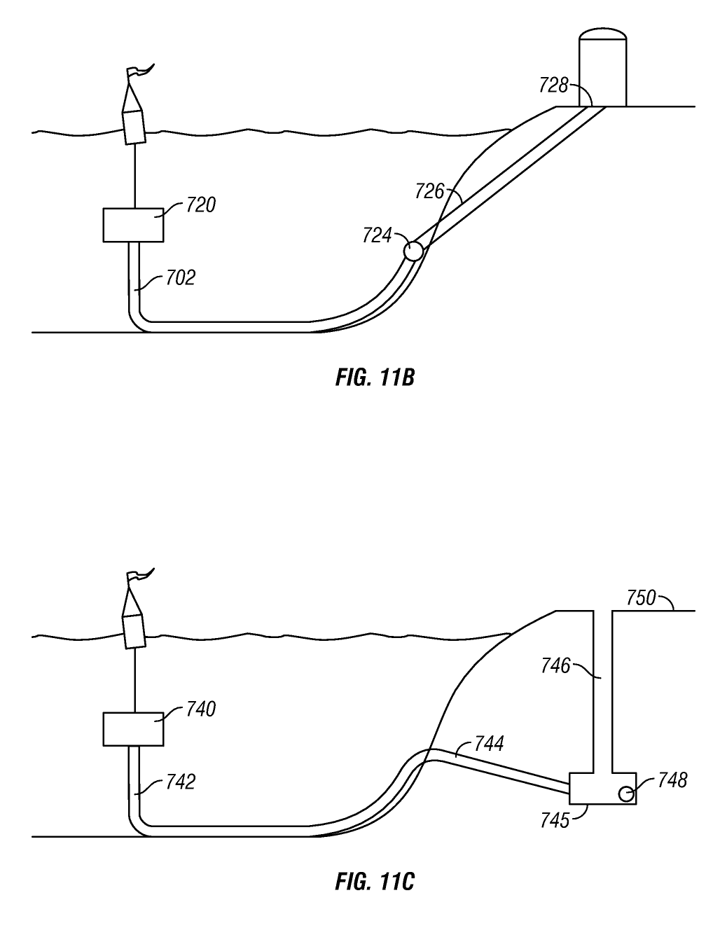

A diagram of a DEMWAX™ system of a preferred embodiment is shown in FIG. 1. Tethered to an anchor 100 on the ocean floor are elements of a DEMWAX™ system, including membrane modules 102 and a collection channel 104. The membrane modules 102 can include one or more membrane cartridges, for example as described below in connection with FIG. 9C. These and other elements of the system are preferably configured to be nearly neutrally buoyant so that floats or weights can be added depending upon the application to hold the modules at a desired depth. A breathing tube 106 extends between the collection channel 104 and a buoy 108 floating on the surface of the ocean to expose the collection channel to atmospheric pressure. Alternatively, the breathing tube can follow the permeate pipe 112 to the shore. A pump 110 pumps the permeate from the collection channel 104 to shore through the pipe 112. The pump 110 can be placed within the collection channel or adjacent to it 104, as illustrated in the figure, or can be installed at or near the shore in fluid communication with the pipe 112. The pump is preferably at about the same depth as the membranes so that the backpressure does not stop the reverse osmosis process. If the pump is at a depth of less than 850 feet, it may need to provide negative pressure to the membranes in order to permit the reverse osmosis process to proceed. One or more permeate storage tanks 114 can optionally be disposed within the system, for example, as part of or extending from the collection channel 104, to provide extra storage. Such extra storage can be used advantageously to buffer variations in pump speed. The storage tanks 114 can include sensors (not shown) configured to sense the volume of permeate stored in the tanks 114 and regulate the operation of the pump 110 accordingly.

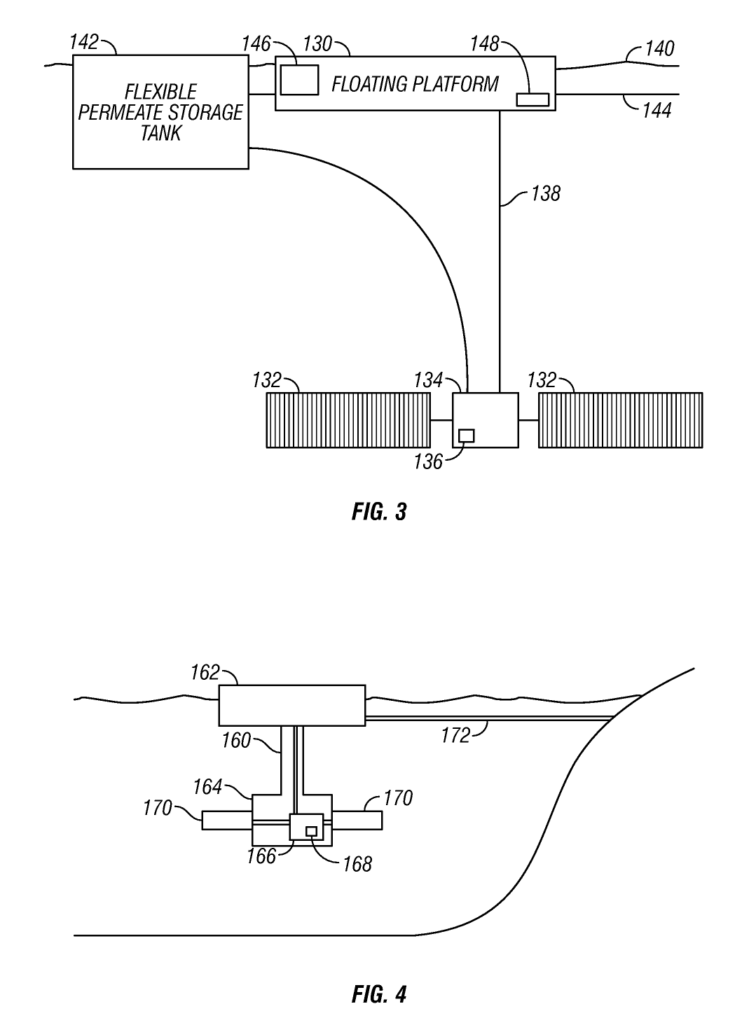

FIG. 2 illustrates another embodiment of a DEMWAX™ system which is especially well suited for temporary (non-permanent) applications. A DEMWAX™ module 120 is tethered to one or more anchors 122 on the sea floor. The module 120 includes at least one membrane cartridge and a collection channel. The membrane module is exposed to the hydrostatic pressure of the ocean at depth, and the collection channel is exposed to atmospheric pressure via a breathing tube 124 which extends to a buoy 126 floating on the surface of the water. Permeate is collected in the module 120 and pumped through a permeate pipe 127 to a mobile storage vessel 128, near the buoy 126, for transport to shore. Systems such as this one can be deployed rapidly in emergency situations, for example, close to areas experiencing water supply contamination or shortages.

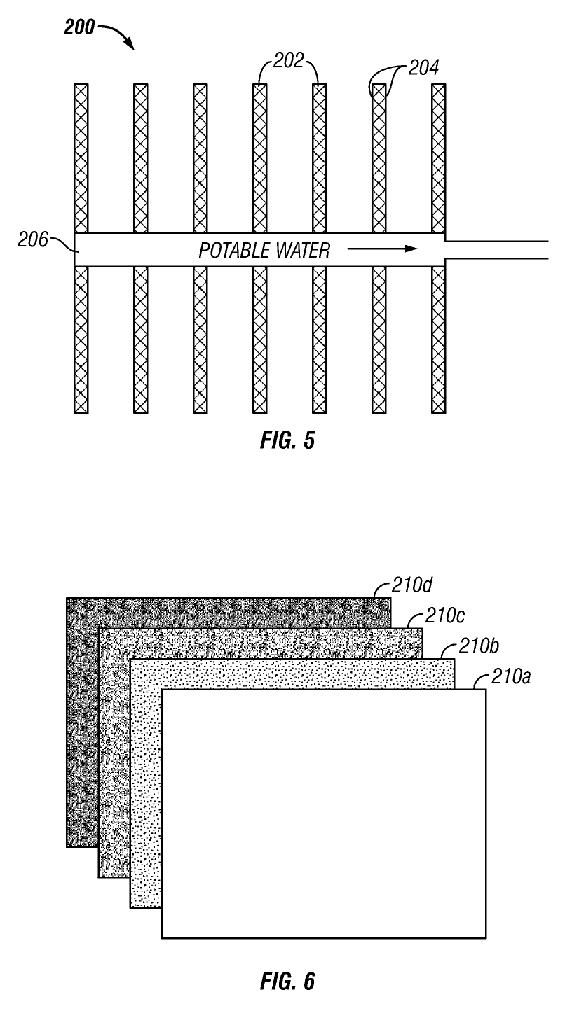

FIG. 3 illustrates an alternative configuration of a DEMWAX™ system. Membrane modules 132 are suspended below a floating platform 130. In the system depicted, the modules 132 produce the freshwater which is deposited into a holding tank or tanks 134 containing submersible pumps, dry well pumps, or the like 136. The interior of the holding tank 134 is maintained at atmospheric pressure, by virtue of a breathing tube 138 that extends between the holding tank 134 and the floating platform 130. The product water can be pumped to the surface 140 and then into a flexible storage tank 142. Although illustrated with the storage tank 142 floating on the seaward side of the platform 130, the storage tank can also be situated in any other appropriate configuration, for example on the landward side of the platform 130 or suspended below the surface 140 of the water. The product water is then pumped to shore through a pipe 144 for final treatment and distribution. Power generation equipment 146 can be provided in the floating platform 130 and configured to provide power to the other components of the illustrated system. A pump 148 can also be provided to move water to shore from storage. Components such as suspension cables, power cables, tethers and anchors are not depicted in FIG. 3, but can be desirably employed in systems such as the one depicted.

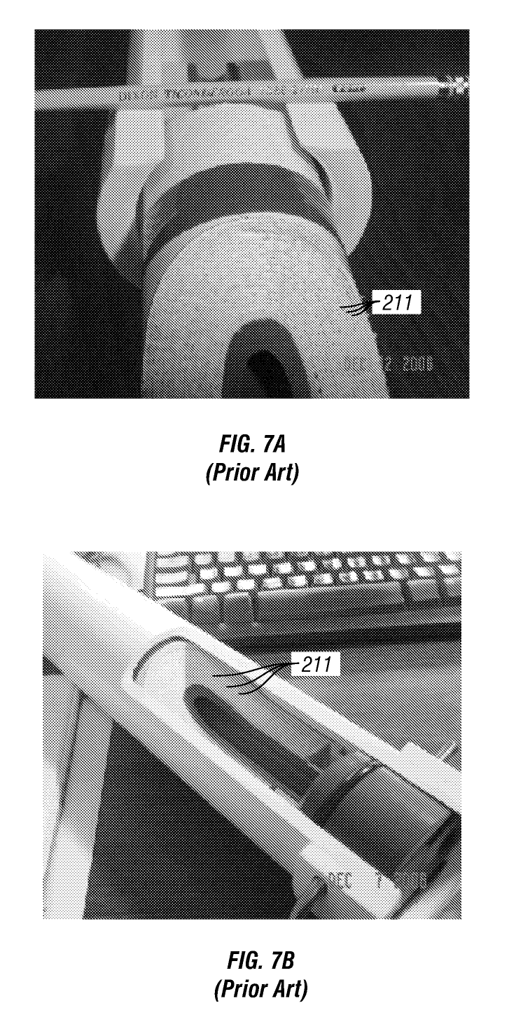

FIG. 4 illustrates another alternative configuration of a DEMWAX™ system, in which a column 160 is suspended from a floating platform 162. The column 160 can be configured to provide access to a lower chamber 164. The chamber 164 can be configured to house various components of the DEMWAX™ system, such as pumps, valves, electrical panels, instrumentation equipment, and other ancillary equipment 168. The chamber 164 can be sized large enough to allow workers to access the chamber to maintain equipment. Membrane modules 170 can be arrayed outside the chamber 164, exposed to the surrounding feed water, but with permeate portions in fluid communication with the collection channels and system 166. The collection system 166 can be exposed to the interior of the chamber 164, which, in turn, can be exposed to atmospheric pressure via the column 160. By such a configuration, the chamber 164 itself can function as a “breathing tube” for the collection system 166. A separate breathing tube can also follow the outside of the column to the surface. The collection system 166 can be fluidly connected to a pipe 172 configured to transport product water to storage or to shore. Systems of preferred embodiments such as these are particularly advantageous for large applications, and can employ larger membrane cartridges, larger membrane modules, and/or larger arrays of membrane modules than other embodiments. Such systems advantageously offer additional flexibility in choice of pumps, as well as ease of access to pumps and other equipment for maintenance purposes. In this application, other type of pumps than submersible can be used. The column 160 and chamber 164 can comprise of a structurally strong, stable and corrosion material such as concrete, so that the system can remain less affected by waves or ocean currents. Such a system may, but need not, be tethered to the ocean floor as described above in connection with FIG. 1.

Although the descriptions above make particular reference to ocean applications, similarly configured systems—both free-floating and anchored—can be utilized with embodiments configured for freshwater or surface water applications as well.

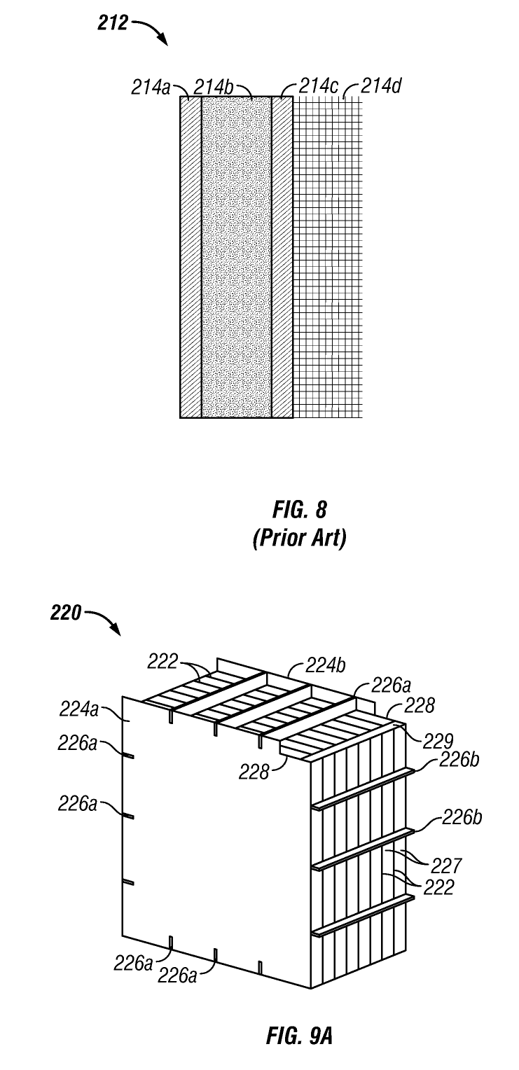

One configuration of a DEMWAX™ membrane module 200 utilizes vertically aligned membrane cartridges composed of membrane units or elements 202 in a box configuration. A simplified cross section of one such module is shown in FIG. 5. The membrane elements 202 are preferably spaced close together, but not so close that surface tension substantially impairs the ability of gravity to draw down the higher density seawater generated at the membrane surfaces 204 by the filtration process. The minimum spacing to avoid significant surface tension effects can depend upon various factors, including membrane chemistry, but is generally about 1 mm or more, preferably about 2 mm or more, more preferably from about 2 mm to about 25 mm, and most preferably from about 5 mm to about 10 mm. In certain embodiments, a spacing less than 1 mm can be acceptable or even desirable. Likewise, in certain embodiments a spacing of more than 25 mm can be acceptable or even desirable. It is generally preferred to minimize the spacing so as to maximize the membrane surface area per footprint of the installation.

FIG. 5 is not to scale and exaggerates the distances between the membranes for illustrative purposes. The diagram shows a total of seven membrane elements 202 on either side of a collection channel 206; however, in preferred embodiments a larger number of elements can be employed, depending upon the amount of water to be generated or other factors. In preferred embodiments of the seawater DEMWAX™ system, the module typically contains hundreds of these elements spaced about ¼ of an inch (about 6 millimeters) from one another. Spacing between membrane elements depends on several factors including (but not limited to) total dissolved solids in the feed water; height of the membranes and velocity of the ambient currents. In surface or freshwater applications, a spacing of about ⅛ of an inch (about 3 millimeters) between membrane elements can be desirably employed.

In systems of preferred embodiments, membrane modules and/or cartridges can be vertically arrayed or arrayed in any other suitable configuration, e.g., tilted off vertical, or horizontal if ocean currents are present. In certain embodiments, the modules can converge at a rigid casing where the freshwater flows from the membrane modules to collector channels. To provide efficient operation of such reverse osmosis systems, the surface area of the membrane that is exposed to high pressure saltwater is preferably maximized per unit of footprint area, e.g., by placing the membrane elements extremely close together in a parallel ‘fin’ configuration (e.g., similar to the ‘fins’ in a radiator or heat exchanger).

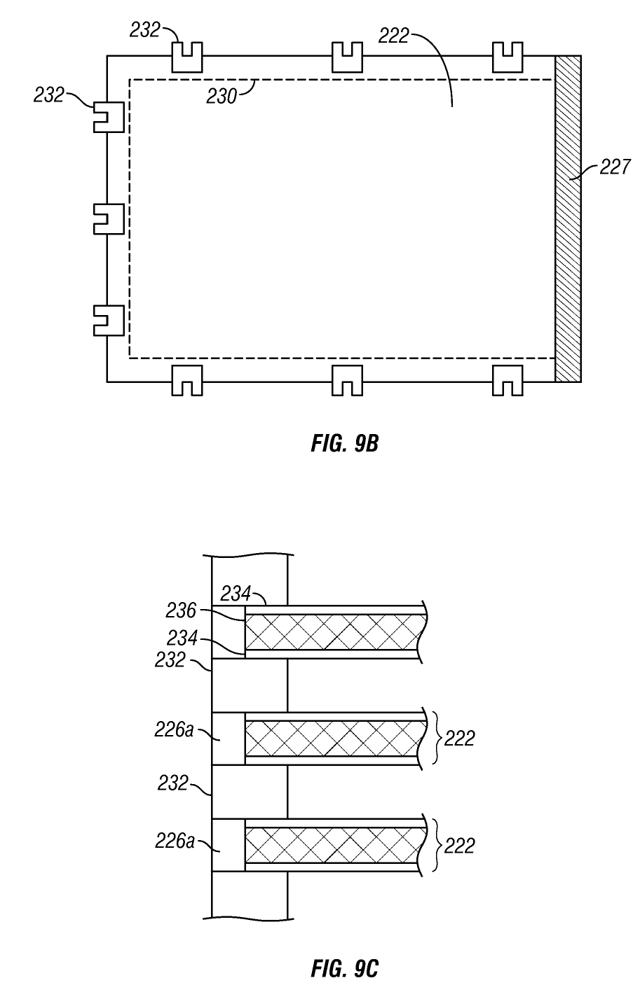

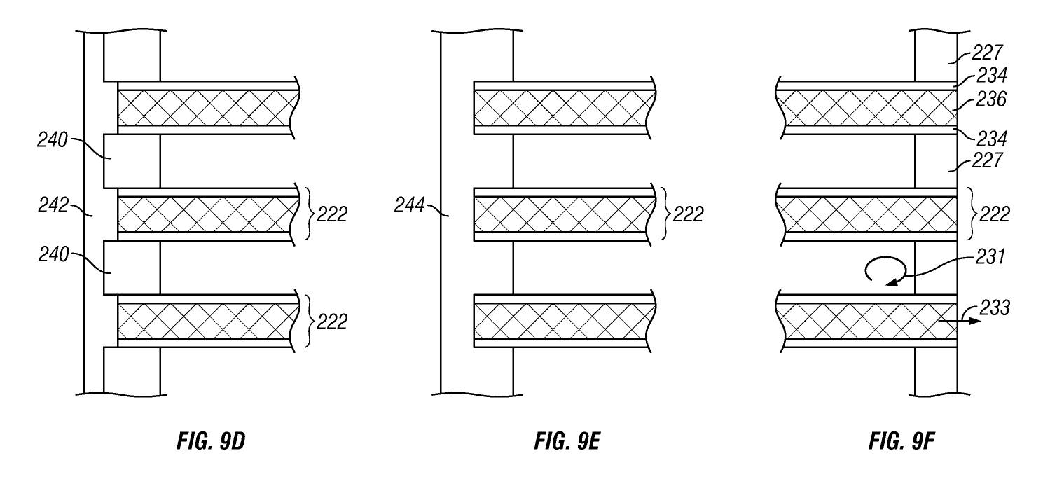

Alternatively, a configuration of the membrane modules of selected preferred embodiments can be similar to that of conventional reverse osmosis membrane modules. For example, depicted in FIG. 6 are four rectangular sheets 210(a) through 210(d). The four sheets that make up the reverse osmosis membrane element depicted in FIG. 6 include: a polyamide membrane 210(a); a permeate spacer 210(b) (e.g., to separate the two membrane sheets 210(a) and 210(c) so freshwater can flow between them); a second poly-amide membrane 210(c); and a raw water spacer 210(d) (e.g., to separate the membrane elements from one another so that raw saltwater can flow between them). FIG. 6 shows these sheets prior to being joined, rolled and inserted into a pressure vessel. The spacers 210(b) and 210(d) are porous to allow the water to flow therethrough. The raw water flows to the entire membrane surface and the permeate flows to the collection system. Typical dimensions of the sheets that can advantageously be employed are about three feet (0.91 meters) or three feet four inches (1 meter) by eight feet (2.44 meters); however, any suitable dimensions can be employed. It can be preferred to employ membrane sheets of a width and/or length as available from the membrane manufacturer; however, any suitable size can be employed. Sheets larger in one dimension can be obtained by bonding together narrower lengths using techniques as are known in the art, or can be manufactured in any desired dimension. It is generally preferred to employ a unitary sheet, as such sheets generally exhibit greater structural integrity than those prepared from smaller sheets joined together at a seam. Likewise, when a membrane is fabricated into a flat sandwich configuration, it can be desirable to fold the membrane (or any other sheet component employed in the system) to form one side of the sandwich, thus minimizing the number of seals and/or bonds and thereby increasing structural integrity of the system, unless the fold imparts a weakening of the membrane's properties. Prior to being rolled, three sides of these sheets (two membrane sheets and the permeate spacer) are sealed. The fourth side is left open and joined to the permeate pipe so that the product water can be moved to the collection system. Any suitable sealing method can be employed (e.g., lamination, adhesive, crimping, heat sealing, etc.). The dimensions of these elements in a conventional spiral-wound module are presented in FIGS. 7A and 7B. The photographs show cutaways of a reverse osmosis membrane module having twelve layers 211 of membrane wrapped around a permeate tube. In the radius of about one-half of an inch (12.7 millimeters), there are twelve layers of the four sheets described above in connection with FIG. 6. The flow space between membranes in such conventional systems is typically very small, but the pressures employed are high, allowing a large membrane surface area to be fit into a small space. In the membrane cartridges of preferred embodiments, the spacing between the membrane elements is not small as in conventional reverse osmosis systems such that surface tension substantially affects the flow of feed water between the membrane elements. Instead, the spacing is large enough that the volume of feed water flowing between the membrane elements is sufficient to maintain osmotic pressure in the space between the membranes, but small enough to fit a large membrane surface area into a relatively small volume.

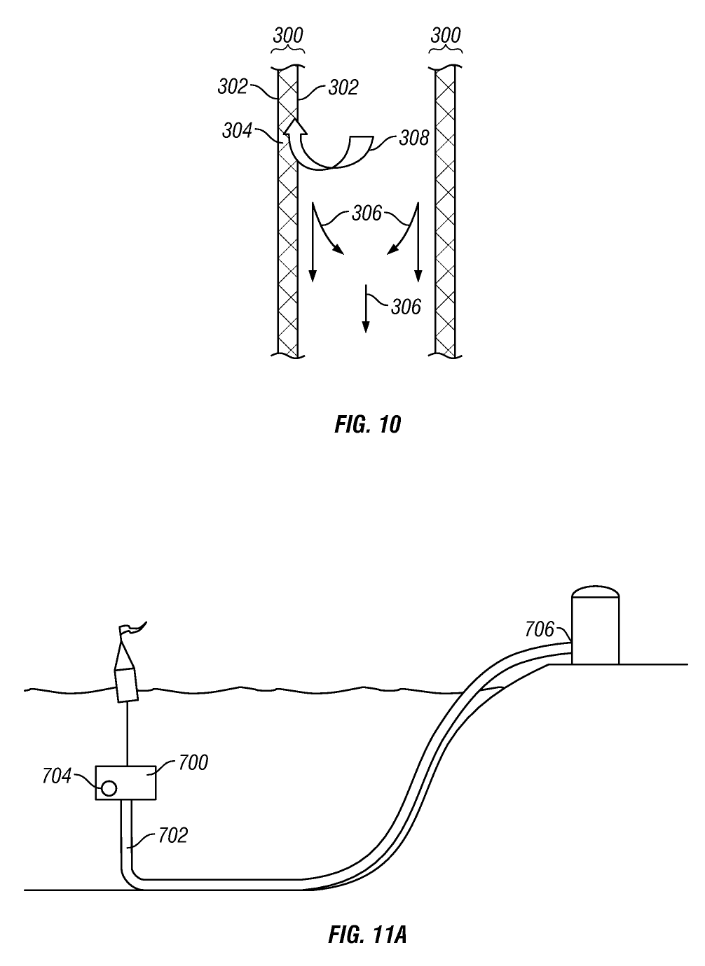

FIG. 8 shows a cross section of a membrane element 212 from a conventional reverse osmosis unit (prior to being rolled). In preferred embodiments, rather than winding membranes around a collection device, the membranes 214(a), 214(c) and permeate spacer 214(b) are arrayed vertically, such that the raw water spacer 214(d) can be replaced with an actual space, although in certain embodiments a polymer or other spacer sheet can be employed.

### Membrane Cartridge

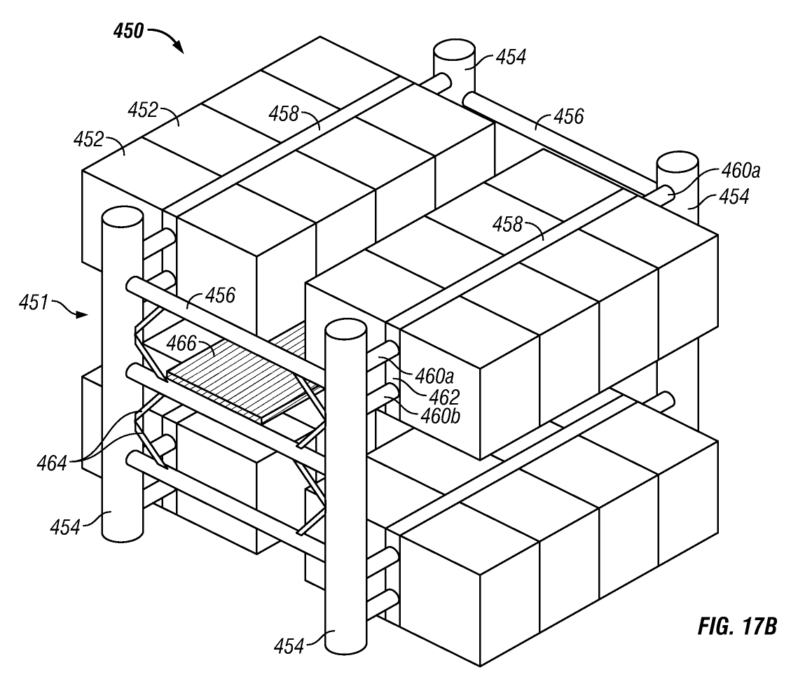

FIG. 9A shows a perspective view of a membrane cartridge 220 configured according to a preferred embodiment. The cartridge 220 includes one or more membrane elements 222 disposed substantially within a casing comprising two side walls 224(a), 224(b). One or more rigid dowels 226(a) extend between the side walls 224 at the top, bottom, and rear of the cartridge 220 to maintain the spacing of the side walls 224 and to provide structural support to the cartridge 220. One or more rigid dowels 226(b) extend between the side walls 224 at the front of the cartridge 220 to perform this same function, as well as to provide space for permeate to flow through the front of the cartridge 220 (see, e.g., the discussion of FIG. 17A, below). The dowels 226(a), 226(b) are shown extending to the side walls 224; however, other configurations are possible. The dowels 226(a), 226(b) can also be configured to maintain the spacing between the membrane elements 222, although separate spacing means can also be provided to perform this function. At the front end of the cartridge 220, the membrane elements 222 are separated by one or more sealing spacers 227 extending from the top ends of the membrane elements 222 to the bottom ends of the elements 222. Together, the sealing spacers 227 form a front wall 229 of the cartridge 220. The sealing spacers 227 are configured to provide a watertight seal separating the source water flowing between the membrane elements 222 from the permeate flowing through the membrane elements 222 and into the collection system at the front end of the cartridge 220. The side walls 224(a), 224(b) can each include one or more notches 228 or other features configured to mate with a corresponding structure of the collection system, to facilitate collection of permeate through the front ends of the membrane units 222. The membrane cartridge 220 can be configured to withstand the hydrostatic pressure to which it will be exposed during operation, and can comprise materials suitable for the particular application. The diagram shows a total of seven membrane elements 222 in the cartridge 220; however, in preferred embodiments a larger or smaller number of elements can be employed, depending upon the amount of water to be generated, the desired spacing between the membranes, or other factors. FIG. 9A is not to scale and exaggerates the distances between the membrane units 222 for illustrative purposes (for example, a membrane cartridge of one preferred embodiment can be one meter tall with spacing between the membrane elements just 6 millimeters).

FIGS. 9B through 9F illustrate steps in the process of manufacturing a membrane cartridge 220. To build a membrane cartridge, a number of membrane units or elements 222 are first prepared. Each membrane element 222 comprises two membranes 234 spaced apart by a permeate spacer sheet 236. The top, bottom, and rear edges of each membrane element 222 are sealed, as indicated by the dotted line 230 in FIG. 9B, leaving the front edge (the right side of FIG. 9B) of the membrane element 222 open. The sealing of the edges can be accomplished using adhesive, crimping methods, heat sealing or any other suitable method capable of forming a seal that can withstand the pressure differential between the inside and outside of the membrane element. One or more spacers 232 are then attached around the edges of the membrane element 222. The spacers 232 can extend beyond the perimeter of the membrane element 222, as shown in FIG. 9B, or can abut the perimeter. The spacers 232 can optionally include one or more notches, grooves, or openings configured to receive a dowel extending through a series of elements 222. Of course, the spacers 232 can have any other configuration suitable for their intended purpose. At the front end of the membrane element 222, a sealing spacer 227 is attached which extends along the height of the element 222. The spacers 232 and the sealing spacer 227 can be attached or otherwise coupled to the membrane element 222 using adhesive or any other suitable means. Once the spacers 232 and sealing spacers 227 are attached, another membrane element 222 is attached to the spacers 232 and the sealing spacer 227. The process is repeated until a cartridge is constructed having the desired number of membrane elements 222.

FIGS. 9C through 9E show various configurations of spacers in a stack of membrane elements 222. FIG. 9C shows a cross section of a stack of membrane elements 222 which are spaced apart by spacers 232. The spacers 232 extend beyond the edges of the membrane elements 222 to wrap around a continuous dowel 238 which spans the series of membrane elements 222 in the cartridge. Together, the spacers 232 and dowel 238 form a reinforcement structure which spans the series of membrane elements 222 and which can serve as a structural component of the membrane cartridge (see, e.g., dowels 226(a) in FIG. 9A). FIG. 9D shows an alternative embodiment, in which spacers 240 extend beyond the edges of the membrane elements 222. The spacers 240 can be grooved or notched to receive a dowel 242 spanning the series of membrane elements 222, with the dowel 242 fitting into the grooves in the spacers 240. The dowel 242 can comprise, for example, a polymeric material, composite, or metal. FIG. 9E shows a still further embodiment, including a comb-like dowel 244 configured to closely receive each membrane unit 222. In such a configuration, the spacing of the membrane units 222 is maintained by the teeth of the dowel 244, without requiring additional spacers. To manufacture a cartridge of this configuration, a series of membrane units 222 can be inserted into each space between the teeth of the dowel 244. Adhesive or other suitable engagement means can be optionally provided in these spaces to ensure appropriate engagement of the dowel 244 with the units 222. In addition, although illustrated with spacers 232 extending into the area between the membranes 234, embodiments can also employ spacers which do not do so. For example, embodiments can include membrane elements which are sealed (at the top, rear, and bottom edges) by sealing members that extend beyond the membrane area. In such embodiments, the spacers can be disposed between those portions of the sealing members that extend beyond the membrane area, rather than between the membranes themselves.

The front wall 229 of the membrane cartridge 220 is illustrated in further detail in FIG. 9F. As shown in the figure, the sealing spacers 227 are disposed in between each membrane unit 222. The sealing spacers 227 extend along the length of the membrane units 222 (see FIG. 9B) and are configured to separate the source water flowing in between the membrane units 222, as indicated by arrow 231, from the permeate flowing through the permeate spacers 236 and into the collection channel, as indicated by arrow 233. The sealing spacers 227 do not substantially interfere with the flow of permeate between the membrane elements 222. The sealing spacers 227 can be adhered to the membrane sheets 234 using adhesive or any other suitable method.

The footprints of the systems of preferred embodiments are a function of desired capacity, membrane height and the space between membrane elements. For seawater applications, assuming that the membrane elements are spaced at ¼ of an inch (6.35 millimeters), and the membranes are 40 inches (1 meter) tall, for every 1,000 square feet (93 square meters) of membrane cartridge footprint area, the system can produce about 400,000 gallons per day (about 1.6 million liters per day), assuming a flux rate of about 1.5 gpfd (about 61 liters per square meter of membrane per day). Membrane modules can be stacked at depth to further reduce the footprint. If the membrane systems are deployed in an area where water currents are significant, the modules can be more closely stacked than in those areas where water currents are minimal, as the significant currents will facilitate mixing and moving of the concentrate exiting from the top module, thereby equalizing the salinity with ambient seawater within a short distance below the top module. In the absence of significant currents, it can be desirable to provide a system for facilitating mixing and moving seawater across the membranes, e.g., bubblers, jets, or the like.

Any suitable membrane configuration can be employed in the systems of preferred embodiments. For example, one such configuration employs a central collector with membrane units or cartridges adjoining the collector from either side. Another configuration employs membrane units in concentric circles with radial collectors moving the potable water to the central collector.

### Depth of Membrane Modules

In the seawater applications, the membrane modules of preferred embodiments are preferably submerged to depths sufficient to produce desired permeate water by ambient pressure of the seawater against the membrane without application of additional pressure. Such depths are typically of at least about 194 meters, preferably at least about 259 meters. However, depending on the application, the systems of preferred embodiments can be deployed at other depths. The 259 meters depth is preferred for seawater reverse osmosis to produce potable water from seawater of average salinity (e.g., about 35,000 mg/L). If a level of brackishness is permissible (e.g., for water used for irrigation or industrial processes), a shallower depth can be employed. For example, production of brackish water suitable for irrigating agriculture can be achieved with certain membranes submerged to a depth of from about 100 meters to about 247 meters. An acceptable level of brackishness can be selected by selecting the type (e.g., chemistry) of membrane and the depth of the membrane module depending upon the salinity of the ambient seawater. Systems of preferred embodiments utilizing nanofiltration membranes, for example, can be deployed in the ocean at about 43 meters of depth to screen out about 20% of the salinity of the feed water, and also to remove calcium and many other unwanted constituents. Such systems can be employed as offshore pre-treatment systems for onshore desalination plants, expanding the capacity of existing plants and reducing maintenance as well as overall energy requirements by about 50% as compared to standard onshore reverse osmosis plants. Systems of preferred embodiments utilizing ultrafiltration (UF) and/or microfiltration (MF) membranes can also be employed in connection with conventional desalination plants or industrial applications that are not proximate to oceans or other bodies of water of greater depths. Systems of preferred embodiments can be configured for use with industrial applications where the presence of calcium or other undesirable constituents present problems (e.g., corrosion or scale buildup), such as power plant cooling applications. Suitable RO and NF membranes for use with preferred embodiments are available commercially from Dow Water Solutions, Midland, Mich., and from Saehan Industries, Inc., South Korea.

In certain embodiments, systems can be configured for deployment at shallower depths. For example, embodiments can be deployed in shallow ocean waters (for example, at a depth of about 7 meters) and used as low-velocity ocean water intake systems, for example to produce cooling water for an onshore power plant. Such low-velocity intake systems advantageously avoid harming sea life. Such systems can also employ filter fabrics or screens in place of less porous membranes.

In addition, systems of preferred embodiments employing microfiltration, ultrafiltration, or nanofiltration membranes can be positioned in surface waters and reservoirs at depths as shallow as 6 meters and can be configured to filter out bacteria, viruses, organic matter, and inorganic compounds from the source water. For example, systems employing nanofiltration membranes can be positioned at a depth of about 6 to 30 meters or at any other appropriate depth, depending upon the total dissolved solids to be removed and the desired quality of the product water. Systems of preferred embodiments including microfiltration, ultrafiltration, or nanofiltration membranes can also be adapted to produce clean water from a contaminated water supply and configured for placement in ground wells. In freshwater sources with very low levels of dissolved solids, the osmotic pressure of the source water is a less significant factor in the filtration process (generally, every 100 mg/L total dissolved solids in the source water requires 1 pound per square inch (approximately 6.9 kPa) of pressure). Consequently, the transmembrane pressure losses of the membranes become more dominant in determining the required depth for the desired level of treatment.

In certain embodiments, an induced water column can be used to provide pressure to drive the filtration process. Where a stream or river does not have the necessary depth, it can be diverted into an artificial vessel similar to a large, deep pool. The DEMWAX™ system can be situated in the pool. The pool maintains the flow-through nature of the original water source by flowing the excess water back into the existing river or stream, or into a new location (e.g., diverted for irrigation purposes). Thus, the impurities screened out by the membranes can remain where they were naturally, e.g., in the river or stream. The amount of impurities returned to the river or stream are typically sufficiently small such that their return does not significantly alter the chemistry of the body of water from its natural state. The systems employed in such applications typically necessitate diverting an excess of water; however, the gravity flow of the original water source typically eliminates the need for much (if any) artificial pumping energy. Membrane modules can also be situated within pressure vessels or tanks. A water column can be induced by pumping source water into the tank. In the case of streams that have significant elevation changes (mountainous area), the water can be directed to flow into a feed tank situated at a preselected height above the pressure tank with the modules to induce the desired water column height.

It is preferred to situate the DEMWAX™ module at a sufficient distance from the floor of the water source so as to avoid membrane fouling by silt, sediments, and other suspended solids typically present at higher concentration near the floor of water bodies. Preferably, the seawater DEMWAX™ module is situated at least a couple hundred feet from the ocean floor; however, in certain embodiments it can be acceptable to situate the DEMWAX™ module at depths closer to the ocean floor.

Likewise, if it is desirable to employ the system at a location wherein the ocean is shallow such that a depth of 259 meters cannot be attained (e.g., certain locations proximate to shore), in such preferred embodiments a two-pass system can be employed. By submerging a nanofiltration membrane to shallower depths (e.g., about 152 meters), the systems of preferred embodiments can produce brackish water at about 7,000 ppm salinity. Such brackish water can then be subjected to another reverse osmosis process (e.g., on land, on a platform offshore, or at any other suitable location) at a substantially lower total operating cost than conventional reverse osmosis systems to achieve potable water. Alternatively, the floor of the body of water can be excavated to provide a cavity, chamber or passage permitting situating the membrane module at a desired depth.

In preferred embodiments, the first pass of a two-pass process uses a DEMWAX™ system with nanofiltration membranes to produce water with an appropriate reduction in salinity. The reduced salinity water is pumped to the shore, where it is subjected to a second pass filtration process to reduce dissolved ion concentrations to those characteristic of potable levels with an approximate 80% recovery rate. The second pass filtration process can employ a conventional spiral wound reverse osmosis or nanofiltration membrane system. The brine generated by this process is as saline as or slightly less saline than the original seawater. Thus it can be disposed of (e.g., back into the ocean) without the environmental concerns associated with the more highly saline brine generated in conventional land-based reverse osmosis systems that can be nearly twice as saline as the original seawater. The two-pass process is also more energy efficient than conventional land based desalination. It only consumes about 7.5 kWh per kgal (about 2 kWh per cubic meter) total for both passes of the process (a first pass through a DEMWAX™ system at a 500 foot depth and six miles offshore, and a second pass onshore in a conventional desalination process), in contrast to state of the art onshore reverse osmosis plants consuming over 16 kWh per kgal (about 4.2 kWh per cubic meter) or more. Such a system can be used to advantage in, for example, the Red Sea, to produce cleaner feed water (that is, feed water of lower salinity and lower concentration of other undesirable constituents such as calcium) for an existing conventional on-shore RO desalination system, improving efficiency and lowering maintenance costs of the system.

Different seawaters possess different salinities (e.g., the salinity of the Red Sea (40,000 ppm) is higher than the North Atlantic (37,900 ppm), which in turn is higher than the Black Sea (20,000 ppm)). The salt content of the open oceans, free from land influences, is rarely less than 33,000 ppm and seldom more than 38,000 ppm. The methods of preferred embodiments can be adjusted or modified to accommodate seawater of different salinities. For example, the preferred depth for submerging the DEMWAX™ systems of preferred embodiments is deeper in more saline water (e.g., Red Sea), and is shallower in less saline water (e.g., Black Sea). The depths referred to herein are those preferred for water of average salinity (33,000 to 38,000 ppm, preferably about 35,000 ppm), and can be adjusted to accommodate higher or lower salinity water.

### Spacing Algorithm

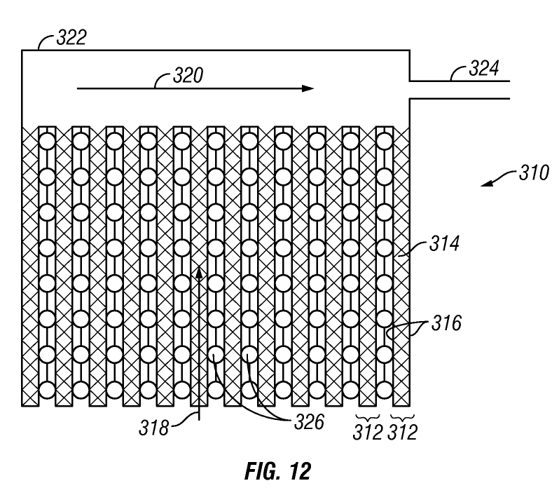

The membrane elements are preferably spaced at a distance that allows the free flow of raw water therebetween, and in the case of high dissolved solids (i.e. seawater), that approximately maintains the osmotic pressure of the feed water throughout the space between the membrane elements. The flow of permeate, feed, and generated concentrate (e.g., brine) in a DEMWAX™ membrane module of a preferred embodiment is depicted in FIG. 10, which shows two spaced-apart membrane elements 300. Each membrane element 300 comprises two membranes sheets 302 spaced apart by a permeate spacer 304. As discussed above, the space allowed for raw water flow between membranes in conventional desalination pressure vessels is extremely small. The systems of preferred embodiments preferably employ larger spacings to facilitate seawater or other raw water to flow naturally to the membrane surfaces 302 using gravity to draw the higher density saltwater generated at the surfaces down, as indicated by the arrows 306, thereby drawing the ambient-salinity seawater from above. The faster the current to which the membranes 302 are exposed, the faster the concentrate is disposed, allowing greater volumes of feed water to contact the membranes 302. The arrow 308 indicates permeate water penetrating the membrane. The systems of preferred embodiments can also be configured to operate in water with no current, utilizing convection flow generated by denser concentrate pulled downward by gravity.

To maximize plant output per unit of plant ‘footprint’, closer spacing is typically preferred. An algorithm has been developed that takes into consideration several parameters in determining the preferred spacing of the membrane elements, depending upon the conditions present.

The exogenous variables used to determine the preferred spacing include membrane element height, concentrate velocity, flux, recovery, and raw water spacer volume (if any). The distance between the top and the bottom of the membrane element determines how far the brine falls before meeting regular seawater. With no change in velocity, flux or recovery, a taller element is preferably spaced further from a neighboring element than a shorter element. As potable water penetrates the membrane, the remaining brine is heavier due to its higher salinity and gravity causes the heavier brine to fall, drawing more original seawater down from the top of the system. The amount of freshwater that penetrates each unit of membrane surface area varies depending on the flux of the system. Flux is typically measured as gallons of permeate per day per square foot of membrane surface area (or, alternatively, as liters of permeate per day per square meter of membrane surface area), and the higher the flux, the less membrane surface is required per unit of permeate capacity. Flux rates can vary according to membrane materials, seawater salinity and depth (pressure). The percentage of water that is exposed to the membranes that actually penetrates is referred to as the rate of ‘recovery.’ While high recovery rates (on the order of 30% to 50% or more) are typically critical to commercial viability in conventional onshore desalination plants, they are typically only of minor significance in the systems of preferred embodiments. At a 50% recovery rate for an onshore plant, the system must treat, pressurize, or otherwise process twice the volume of saltwater than freshwater produced. The systems of preferred embodiments do not require mechanically produced pressure, feed water pre-treatment or brine disposal as in conventional land-based water treatment and desalination systems, thus a high recovery rate is of lesser significance. According to some embodiments, a lower recovery rate is desirable, as a higher the recovery rate results in higher-salinity feed water contacting the lower portions of the membrane elements. The estimated recovery rate for the seawater DEMWAX™ systems of preferred embodiments is about two percent (2%). The higher the recovery, the less water that must be exposed to the membrane surface. If a raw water spacer is used, its volume must be considered in the determination of the spacing of the membrane elements.

The membrane spacing algorithm employed in configuring selected systems of preferred embodiments is specified below. While membrane spacings according to this algorithm are particularly preferred, any suitable spacing can be employed.

$$S = \frac{F H}{k R V}$$

wherein S is the space between membrane elements measured in millimeters (or inches); F is the flux of the system measured in liters per square meter per day (or gallons per square foot of membrane surface area per day); H is the height of the membrane elements in meters (or inches); R is the recovery (% of water flow exposed to membranes); V is the velocity of the falling brine between the elements measured in meters per minute (or feet per minute); and k is a constant which is equal to 720 (when flux is measured in liters per square meter per day, height is measured in meters, and velocity is measured in meters per minute) or 5,386 (when flux is measured in gallons per square foot per day and height is measured in inches and velocity is measured in feet per minute).

Thus, for a 36 inch (in height) membrane element with a two percent recovery and flux of two gallons per square foot per day with brine falling at three feet per minute, a preferred spacing is 0.223 inches.

$$0.223 = \frac{2 \times 36}{5 , 386 \times 0.02 \times 3}$$

If a raw water spacer is employed, for example, to maintain structural integrity when the ambient conditions (water currents, etc.) result in disturbance of the membranes, the volume of the spacer preferably proportionately increases the spacing between membrane elements. For example, if a spacer occupies 20% of the volume between membrane elements, the distance between membranes is increased such that the volume between the membranes is increased by 20%.

### Breathing Tube and Holding Vessel

In order for the water to flow through the membranes, a pressure differential across the membranes must be maintained. Preferably, this is accomplished by evacuating the holding vessel with a submersible pump or dry well pump and exposing the vessel to atmospheric pressure using a breathing tube. The preferred approximate size of a breathing tube for use in a five million gallon (nineteen thousand cubic meters) per day module is five inches (12.7 centimeters) in diameter; however, other suitable sizes can be employed. The breathing tube can be fabricated from any suitable material. For example, the breathing tube can be constructed from a polymer, metal, composite, concrete, or the like. The breathing tube is configured to withstand the hydrostatic pressure to which it is exposed during operation without collapsing. Structural integrity can be provided by the material itself, or through the use of reinforcing members (ribs on the interior or exterior of the tube, spacers inside the tube, or the like).

In a preferred embodiment, a breathing tube is connected to the holding vessel under water. One or more submersible pumps, dry well pumps, or the like can be situated in the holding vessel, which can be provided a pipeline to convey the water to its intended destination (e.g., a larger storage vessel). The preferred size of the holding vessel is a function of the pump operational requirements.

### Pumping Energy

The systems of preferred embodiments efficiently use hydrostatic pressure at depth instead of pumps to power the reverse osmosis filtration process, and thus do not require the vast amounts of energy needed in conventional land-based desalination systems. The systems of preferred embodiments employ pumping systems to pump the product water generated to the surface and then to the shore, but such energy requirements are substantially lower than those required to desalinate water in land-based systems. Given the head pressure at depth, far more energy is typically needed to pump water to the surface than to pump water from the surface to the shore. For systems of preferred embodiments employing conventional reverse osmosis polyamide membranes, an operating depth of 850 feet is employed to produce potable water from seawater. For other membrane chemistries or when purifying water of different salinities (freshwater, brackish water, extremely saline water), lower depths or higher depths may be required to obtain water of the same reduced salt content.

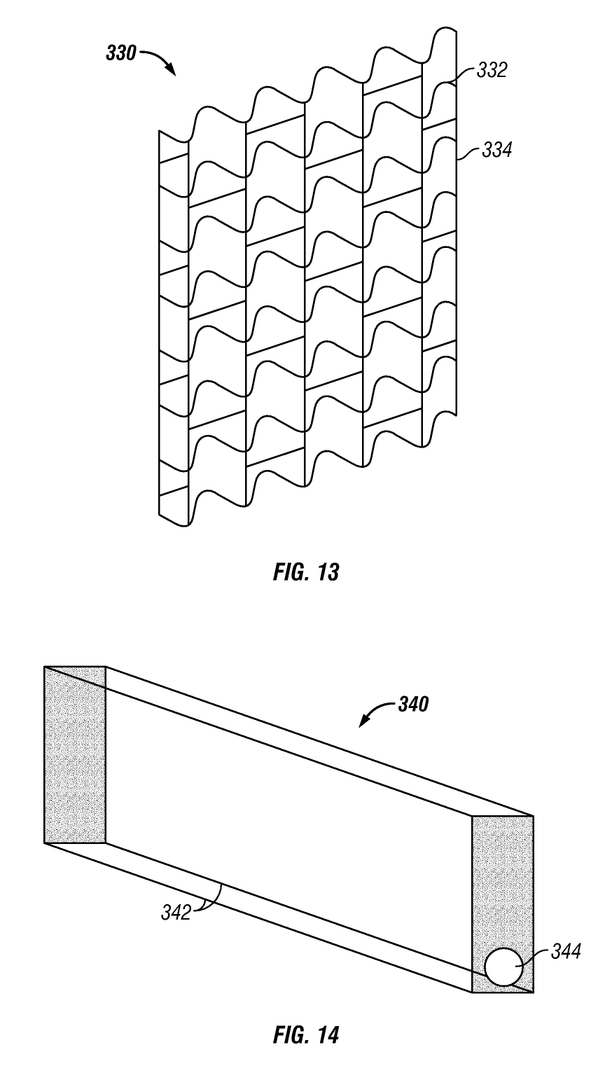

FIGS. 11A through 11C illustrate various configurations for pumping permeate to shore from an offshore DEMWAX™ system. FIG. 11A shows a DEMWAX™ system 700 suspended at depth. The system 700 includes one or more membrane modules (or arrays of modules) and a collection system exposed to atmospheric pressure via a breathing tube, as described herein. The system 700 is connected to a permeate pipe 702, which can include flexible and/or rigid portions. The permeate pipe 702 can extend from the suspended system 700 down to the ocean floor, then run across the ocean floor and up to shore. The suspended system 700 also includes a pump 704 configured to convey permeate through the pipe 702 and up to shore. Because the collection system in the suspended system 700 is held at atmospheric pressure, the head pressure that the pump 704 must overcome to pump the permeate up to shore in this configuration is a function of the vertical distance between the suspended system 700, the elevation of the permeate pipe outlet, and the system headloss of the pipeline connecting the treatment system to the shore 706.

FIG. 11B shows another DEMWAX™ system 720 suspended at depth. The system 720 includes one or more membrane modules and a collection system exposed to atmospheric pressure via a breathing tube, as described herein. The system 720 is connected to a permeate pipe 702, which may comprise flexible and/or rigid portions. The permeate pipe 702 can extend from the suspended system 720 down to the ocean floor, then run across the ocean floor and partway up to shore. The permeate pipe 702 enters a tunnel 726 at a location vertically below the suspended system 720. Because the collection system in the suspended system 720 is held at atmospheric pressure, and because the pumping is done from a location vertically below the suspended system 720, the suspended system 720 need not include a permeate pump to transfer the permeate to land. A pump 724 can instead be provided where the permeate pipe 702 enters the tunnel, to pump the permeate up to the surface 728.

FIG. 11C shows another DEMWAX™ system 740 suspended at depth. The system 740 includes one or more membrane modules and a collection system exposed to atmospheric pressure via a breathing tube, as described herein. The system 740 is connected to a permeate pipe 742, which can include flexible and/or rigid portions. The permeate pipe 742 can extend from the suspended system 700 down to the ocean floor, then run across the ocean floor and partway up to shore. The permeate pipe 742 enters the land at a location vertically below the suspended system 740, at the top of a tunnel 744 which leads to a wet well 745. An access shaft 746 extends from the ground surface 750 down to the wet well 745. Because the collection system in the suspended system 740 is communicated with atmospheric pressure, and because the permeate pipe 742 terminates at a location vertically below the suspended system 740, the suspended system 740 need not include a permeate pump to transfer the permeate to land. In addition, because the permeate pipe 742 enters the land at a location vertically above the well 745, no pump is required at the point of entry into land. The system 740 need only be suspended a short distance (for example, a foot or two (about a third of a meter)) vertically above the well 745 to transport permeate to shore without the use of a pump. A pump 748 can instead be provided in the wet well 745 to pump the permeate up to the surface 750 via the access shaft 746. One advantage of this system is that all moving parts (i.e. pumps) are easily accessible on land or below the earth rather than offshore and at depth.

As discussed above, the systems of preferred embodiments offer substantial energy savings over conventional land-based seawater desalination systems. For example, the energy to bring freshwater from 850 feet below the sea to the surface and the energy to pump the water six miles to shore is calculated as follows, and shows that the vast majority of the energy requirement is in bringing the water to the surface:

$$H P = \frac{H F}{p E}$$

wherein HP=Horsepower; H=Total dynamic head in feet; F=Water flow in gallons per minute; p=Pumping constant 3,960 (for head in feet and flow in gpm); and E=Pump efficiency (assumed at 85% which is typical for large pumps).

To pump five million gallons of potable water per day (or 3,472 gpm) (about 18.9 million liters, or 13,144 liters per minute) to the surface, the horsepower is calculated as follows:

$$H P = \frac{850 feet \times 3 , 472 gpm}{3960 \times 0.85} = 876.8$$

As the desalination industry typically compares system efficiencies using the units of kilowatt-hours per thousand gallons (or kWh per cubic meter), the horsepower is converted to kilowatts using the conversion factor 0.745 kilowatts per horsepower:

876.8 horsepower×0.745=653.2 kilowatts

Thus, 653.2 kilowatts will power a pump with the capacity of 3,472 gallons per minute (5 million gallons per day, 18.9 million liters per day, or 13,144 liters per minute). The energy consumed over that period is 15,677 kilowatt-hours. The ratio of the energy requirement to the water pumped yields a value of 3.14 kilowatt-hours per thousand gallons.

To pump the water to shore, the energy requirement is calculated as follows. The same formula as above is used, but a design value of six feet (1.83 meters) of head pressure loss for each 1,000 feet (305 meters) of horizontal distance is assumed. Assuming a six mile run (9,656 meters), that is equivalent to 190 feet (58 meters) of head loss (5.28 thousand feet per mile×six miles×six feet=190 feet; (9,656 meters 305 meters)×1.83 meters=58 meters). Under these assumptions, an additional 196 horsepower (146 kilowatts) of pumping power is required to pump the water to shore.

$$H P = \frac{190 feet \times 3 , 472 gpm}{3960 \times 0.85} = 196$$

Converting horsepower to energy yields a 146 kilowatt energy requirement. A 146 kilowatt load for 24 hours (3.506 megawatt-hours divided by the five million gallons) yields an energy consumption of 0.70 kilowatt-hours per thousand gallons.

In addition to the pumping energy, the systems of preferred embodiments typically have station and maintenance energy loads estimated at 5% of the pumping power needs. For example, the total energy use for one system of preferred embodiments is provided in Table 1.

TABLE 1

| | Kilowatt-hours per |
|---|---|
| | Thousand Gallons |
| | (kWh per Cubic |
| Energy Use | Meter) |
| Pump energy to surface | 3.14 (0.83) |
| Pump energy to shore (6 miles) | 0.70 (0.18) |
| Ancillary energy (5% of pump energy) | 0.19 (0.05) |
| Total energy use | 4.03 (1.06) |

This total energy requirement of just four kilowatt-hours per thousand gallons (about 1.1 kWh per cubic meter) is substantially lower than that of state-of-the-art reverse osmosis systems, which typically consume over sixteen kilowatt-hours per thousand gallons (over 4 kWh per cubic meter). For example, the Tuas desalination plant was completed in Singapore in 2005 and its contractor touts it as “one of the most efficient in the world” needing only 16.2 kilowatt-hours per thousand gallons (about 4.3 kWh per cubic meter). Even conventional water sources often require far more energy than the DEMWAX™ system for coastal populations. Table 2 provides data demonstrating the superior energy efficiency of the systems of preferred embodiments compared to those of the Tuas desalination plant and two major water resources for a well-known arid coastal region.

TABLE 2

| | Kilowatt-hours per |
|---|---|
| | Thousand Gallons |
| Water Resource | (kWh per Cubic Meter) |
| California State Water Project | 9.2 to 13.2 (2.4 to 3.5)> |
| Colorado River Aqueduct | 6.1 (1.6) |
| Tuas Desalination Plant | 16.2 (4.3) |
| DEMWAX ™ Sea-Well System | 4.0 (1.1) |

### Advantages of DEMWAX™ System

The DEMWAX™ system offers numerous cost advantages over conventional water resources and more specifically over conventional water treatment and desalination technologies. For example, conventional reverse osmosis systems require relatively high operating pressures (on the order of 800 psi (5,516 kPa)) to produce potable water. The DEMWAX™ system does not require energy to pressurize feed water. As natural pressure at depth is used in the DEMWAX™ system, there is no need for pumps to create it artificially.

No source water handling as in conventional water purification or desalination systems is required in the systems of preferred embodiments. As conventional desalination processes take in feed water and then dispose of brine which has twice the salinity, the components of the systems must be engineered to withstand the corrosive effects of the saltwater and brine. The systems of preferred embodiments do not require that any feed water be handled. Only the membranes and casings are exposed to feed water, thus the components are much less expensive to manufacture because special corrosion-resistant materials are not required for transporting source water and brine or concentrate, they require less maintenance, and they have a longer life. In conventional desalination plants the materials used to withstand the corrosive effect of salt exposure are far more expensive to manufacture than the materials used in the systems of preferred embodiments. Also, given the approximate 50% yield of conventional reverse osmosis systems, two gallons of saltwater must be handled for each gallon of freshwater produced. In the systems of preferred embodiments, by comparison, only the single gallon of freshwater must be handled.

No special intake and pre-treatment systems are employed in the systems of preferred embodiments. Seawater intake systems in conventional reverse osmosis plants are near the shore and surface and, therefore, take in much suspended matter including organic material. This material contributes to membrane fouling and compaction requiring maintenance and reduction in membrane life. In certain embodiments, DEMWAX™ membranes are deployed at depths where reduced light minimizes organic growth. This also obviates the need for pre-treatment systems that screen out the larger solids and organic materials.

No brine or concentrate disposal system is employed in the systems of preferred embodiments operated at depth to produce product water. When the systems of preferred embodiments are employed to generate brackish water at a shallower depth to be further purified in a second process, brine generation is significantly lower than in conventional desalination processes. Likewise, when the systems of preferred embodiments are employed to generate potable water at depth in a one step process (or even two or more step process), brine generation is also significantly lower. Disposing the brine byproduct of conventional reverse osmosis processes has a detrimental environmental impact. Disposal of concentrated brine endangers sea life at the point of disposal. Often, environmental authorities require reverse osmosis plants to dilute the brine with more seawater, at additional cost, before returning it to the ocean, adding another significant component, and thus expense, to the plant.

The systems of preferred embodiments do not have significant land requirements, in contrast to the typical large utility-scale plants that require large tracts of land near the shore in populated areas, which are necessarily expensive. The systems of preferred embodiments typically do not require any land, aside from that necessary to provide access to the water generated, or, in certain embodiments, to provide mixing facilities inland if the water must be additized prior to distribution (e.g., chlorination, fluoridation, etc.). Storage tanks to buffer the continuous production against the variable intra-day demand can be large; accordingly, supply buffering is preferably provided by underwater, flexible tanks tethered offshore. These obviate the need for the large rigid onshore tanks and attendant highly engineered foundations; however, the systems of preferred embodiments can be employed with onshore tanks, where desirable (e.g., with existing tanks). Likewise, in certain embodiments it can be desirable to not employ tanks of any kind. Any excess water generated can be discarded, or the entirety of the water produced can be employed as it is generated. An advantage of such a configuration is reduced equipment expense.

Other benefits of the systems of preferred embodiments include the capacity for constant production. The temperature of water affects the flux (rate at which water penetrates the membrane). As near surface water collected for conventional desalination plants varies in temperature throughout the year, conventional reverse osmosis plant output is also variable. The DEMWAX™ system does not suffer from such fluctuating output since the deep waters to which the membrane is exposed are typically at a relatively constant temperature regardless of the season or weather conditions on the surface.

The systems of preferred embodiments offer superior flexibility when compared to conventional land-based plants. Such conventional plants can be considered hard assets on land that can incur greater risk than the systems of preferred embodiments, which can be employed as a mobile asset at sea and potentially in international waters. The isolation from land and mobility allows the system to be moved to areas of greater need or greater profitability.

The systems of preferred embodiments are conducive to mobile, temporary water production on a large scale for areas affected by natural disasters such as earthquakes and tsunamis that can foul conventional potable water sources. The modular and scalable design of preferred embodiments also lends itself to very large-scale offshore applications. Also, given this modular nature, most of the costs are in the system itself rather than in situ design, engineering, construction and civil work that is subject to far more variables than the controlled factory setting in which the DEMWAX™ cartridges and other components are manufactured.

In addition to cost advantages, the systems of preferred embodiments have significant environmental and production advantages. Environmental advantages include zero brine creation and therefore disposal. A conventional desalination plant takes in seawater and returns about half of it back (in many cases to locations near to the shore) in the form of brine with twice the salinity. Such higher salinity brine has a detrimental impact on the sea life in the area of the disposal. Through dispersion and mixing, the brine eventually dilutes with the seawater, but because of the continuous desalination process, there is always an area around the discharge pipe of a conventional desalination system where sea life is impacted. The systems of preferred embodiments typically purify about 1 to 3 percent of the water that is exposed to the membranes, thus generating only a slightly higher concentration of seawater in the vicinity of the membranes that is far more quickly diluted by the surrounding seawater. Also, at depths of from about 500 feet to about 1,000 feet, far less sea life is present due to the lack of light.

The systems of preferred embodiments also offer significant flexibility of application. For example, systems of preferred embodiments can be employed in freshwater applications to screen out unwanted constituents such as bacteria viruses, organics, and inorganics from water supplies. For example, systems of preferred embodiments adapted for use with freshwater applications have little or no land requirement, and require no source water intake systems or special disposal of concentrate. Further, systems of preferred embodiments adapted for use with groundwater applications can prevent abandonment of contaminated groundwells, where other methods of water treatment are cost-prohibitive. Systems of preferred embodiments for treating surface, ground, or other freshwater sources offer similar advantages to systems for treating sea or saline water.

Water use has a significant environmental impact. To the extent inexpensive water from the ocean can replace the water taken out of natural water flows, such streams and rivers can be returned to their natural state, or more water can be removed upstream to provide for greater inland water needs. The Colorado River rarely spills into the Sea of Cortez in Northern Mexico due to the withdrawals upstream. The Colorado River Aqueduct provides 1.2 billion gallons (4.5 billion liters) of water a day to Southern California. Twelve desalination systems of preferred embodiments each capable of generating 100 MGD (about 378 million liters per day) can replace the Southern California allotment from the Colorado River.

Energy and water are intimately connected. Vast amounts of energy are used in pumping water to the point of use. The systems of preferred embodiments are much more energy efficient than either conventional desalination plants, or water projects such as the Colorado River Aqueduct and the California State Water Project. As such, the increased efficiencies result in lower energy consumption. As most power generation emits greenhouse gases (e.g., coal fired plants), lower unit energy use for water lowers greenhouse gas emissions proportionately.

An added advantage of the systems of preferred embodiments is that conventional and inexpensive technology and materials can be employed in many components of the systems, for example, membrane materials such as polyamides, HYPERLON™-type material for tanks and tubing for water, polyvinylchloride (PVC) for membrane module casings and holding tanks, conventional submersible pumps or dry well pumps, conventional power generation equipment (e.g., engines, turbines, generators, etc.), and conventional platforms (concrete or other materials as are typically employed in offshore platforms, e.g., in the oil production industry) can be employed. Also, membrane materials used in the systems of preferred embodiments typically have a longer life than those employed in conventional reverse osmosis systems, due to lower flux rate and lower operating pressure; thus, lower maintenance and material costs can result. Platforms or buoys employed to support the membrane modules can conveniently be constructed at low cost from pre-stressed concrete, and can be manufactured in a modular format so that they can be mass produced and configured to a specific project by combining various modules (e.g., suspension modules; power generation modules; fuel storage modules; control room modules; spares storage modules; etc.).

Construction of large infrastructure projects such as desalination or power plants typically occurs largely on site. Consequently, schedule and work flow sequence issues as well as site specific engineering add significantly to complexity and costs of construction as compared to common assembly line manufacturing. In contrast, the systems of preferred embodiments can be constructed at a convenient location off site and transported to the desired location for deployment.

The floating platforms that can be employed in systems of preferred embodiments are mobile and can be produced in a few locations in the world and transported to the location needed. Alternatively, stationary platforms constructed on the seabed can be utilized. The systems of preferred embodiments can be connected to existing land-based water systems, e.g., by using short pipe runs beneath the seafloor and trenching for several hundred yards in a near-shore environment.

### Membrane Module

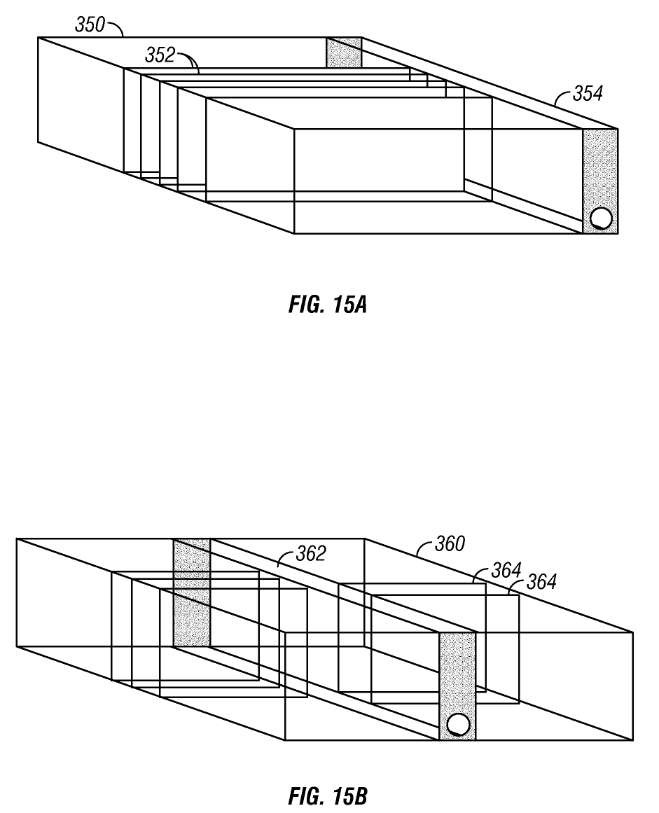

FIGS. 12 to 15 depict various configurations for DEMWAX™ systems of preferred embodiments. FIG. 12 shows a basic diagram (not to scale) of a DEMWAX™ membrane module 310 in plan view, illustrating membrane elements 312 having rigid permeate spacers 314. The rigid spacers 314 maintain the membrane faces 316 separated at depth pressures, facilitating collection of fresh potable water (permeate) from between the opposing membrane faces 316 of each membrane element 312. The flow of permeate is indicated by arrows 318, 320. Seawater (saltwater) circulates freely in the spaces between the membrane sheets 312. A rigid PVC casing 322 at one end of the membrane sheets 312 collects permeate and transfers it to a pipe 324 in fluid communication with a collection system. The membrane sheets 312 are maintained in a spaced configuration by optional saltwater spacers 326, which are placed between membrane sheets 312 on the raw feed side.

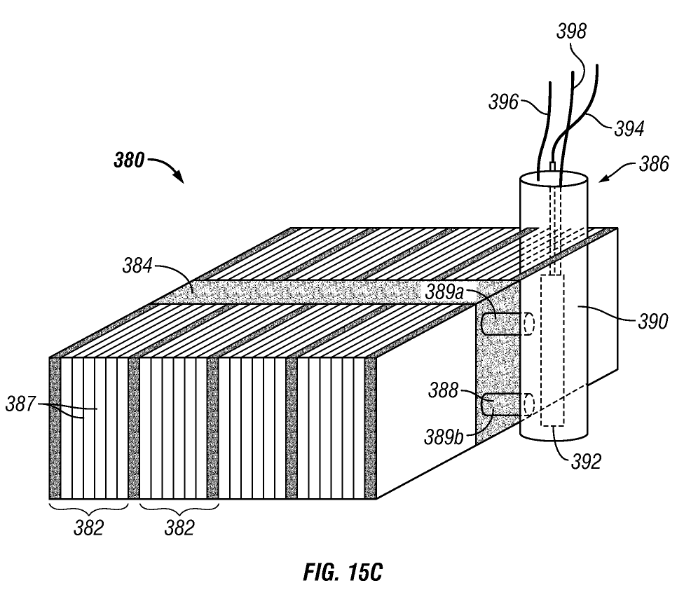

FIG. 13 depicts corrugated woven plastic fibers 330 having corrugated elements 332 and straight elements 334. These fibers are suitable for use as spacers between the membrane units for maintaining sufficient space for the raw water to flow.

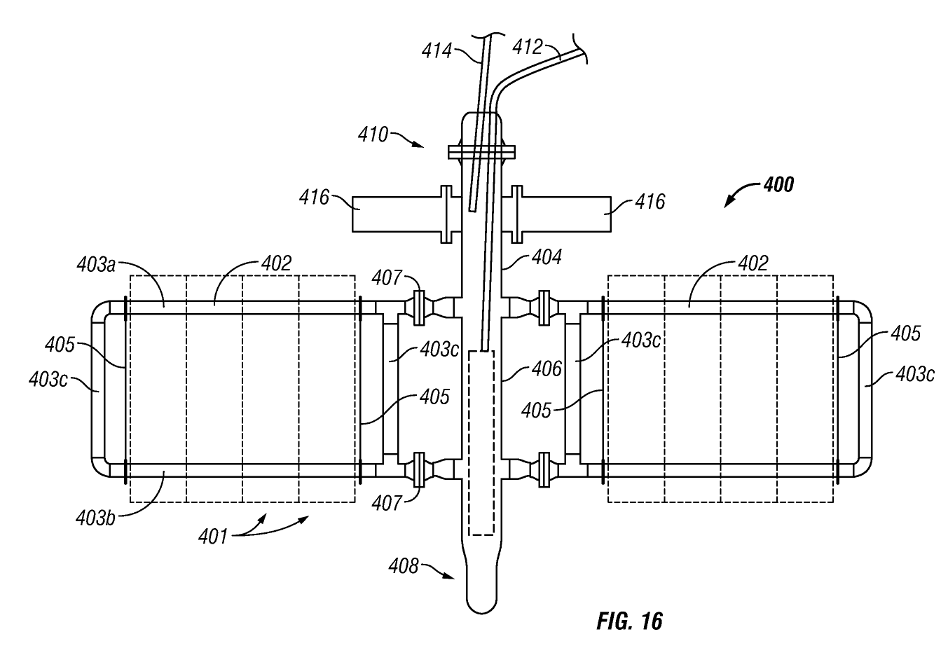

FIG. 14 shows a basic diagram (not to scale) of a collector element 340 for use with the DEMWAX™ system. Horizontal studs (not depicted) are employed to provide structural integrity to the collector element 340 when exposed to pressures at depth, while permitting permeate to flow through the collector 340. Depending upon the material employed in the construction of the collector element, studs (horizontal, vertical, or other configuration, or monolithic or other porous interior support) may be omitted (e.g., when a high strength material capable of withstanding pressures at depth is employed). The collector element 340 can have sides 342 which are slotted to allow for attachment of membrane cartridges or elements, as well as a connector pipe 344 configured for attachment to a collection system.

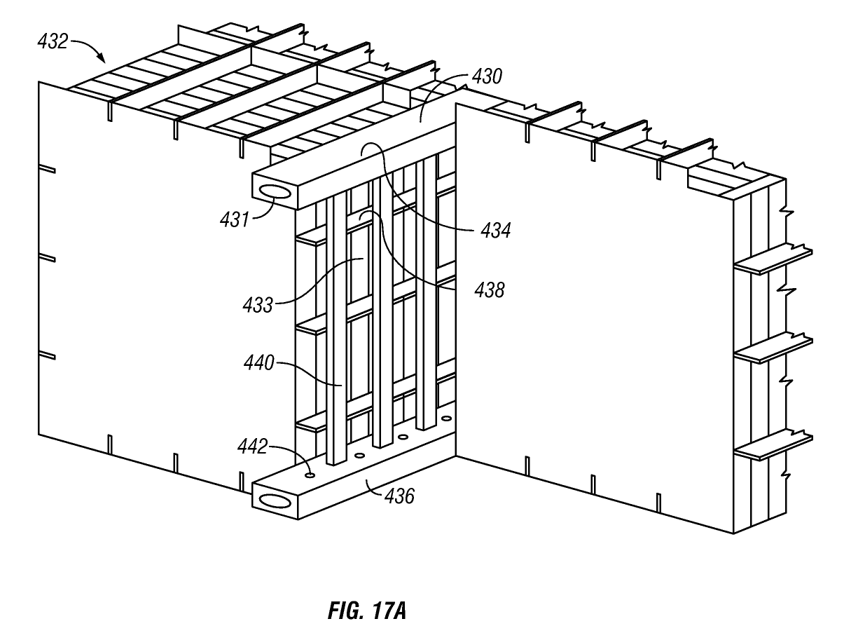

FIG. 15A shows a basic diagram (not to scale) of a casing element 350 for use with the DEMWAX™ system. Membrane units or elements 352 are attached at one end to a collector element 354. The casing 350 maintains the membranes 352 in a spaced apart loose lattice, which maintains structural integrity of the membranes 352, spacing of the membranes 352, and free flow of seawater to the membranes 352.

FIG. 15B provides a view of a membrane module 360 for a central collector element 362 with membranes 364 attached on two sides of a central channel. FIG. 15C shows a membrane module 380 according to a further embodiment, with cartridges 382 coupled to a collection channel 384 having an internal channel 388 extending therethrough. Each cartridge 382 can include multiple membrane units 387. The internal channel 388 is separated from the source water but in fluid communication with the permeate side of the membrane units 387. The collection channel 384 is fluidly connected, via outlets 389(a), 389(b), to a wet well portion 390 of the holding tank 386. Providing two outlets 389(a), 389(b) between the collection channel 384 and the wet well 390 allows for release of trapped air during filling of the internal channel 388. A pump 392 can be provided in the wet well portion 390 and configured to pump permeate through a permeate pipe 394 to offshore or onshore storage. The holding tank 386 is exposed to atmospheric pressure by a breathing tube 396. A power cable 398 can also be provided and connected to an offshore or onshore power generation facility to power the pump 392.

FIG. 16 illustrates a collector system 400 configured according to a preferred embodiment. The system 400 includes two wings 402 comprising pipes or tubes which are formed, bent, connected, or otherwise configured in a frame-like shape to form a collection channel. The placement of membrane cartridges 401 on the wings 402 is illustrated with dashed lines. The top and bottom portions 403(a), 403(b) of the wings 402 can be perforated to allow for permeate to flow from the cartridges 401 into the wings 402. The end portions 403(c) of the wings 402, however, can have solid outer walls, as these portions are exposed to source water. The wings 402 can include end plates 405 which are configured to separate the permeate side of the cartridges 401 from the source water. The wings 402 can also be provided with struts (not shown) for structural reinforcement.

Each wing 402 is fluidly connected, via one or more outlets 407, to a central channel or holding tank 404 which houses a submersible pump 406 (shown in dashed lines). A permeate pipe 412 can extend from the holding tank 404 to temporary storage or all the way to shore. The holding tank 404 can have an enclosed bottom portion 408 which extends below the wings 402. The bottom portion 408 can be configured to house sensing equipment, such as temperature sensing equipment. The holding tank 404 can also have an enclosed upper portion 410 which extends above the wings 402. A breathing tube 414 extends from the upper portion 410 to the surface of the body of water, and is configured to maintain the interior of the collection system 400 at about atmospheric pressure. The upper portion 410 can be provided with sensors (not shown) configured to sense the level of permeate stored in the collection system 400 and regulate the operation of the pump 406 according to demand for product water. The upper portion 410 can optionally include laterally-extending arms 416 configured to provide temporary permeate storage. Temporary storage can also be provided outside the collection system 410, within the path of the permeate pipe 412. The arms 416 can comprise, for example, pipe extensions off the holding tank 404. The wings 402 and the holding tank 404 can have a configuration suitable for their intended purposes. For example, the wings 402 and the holding tank 404 can have a generally circular or generally rectangular cross sectional shape. The wings 402 and the holding tank 404 can also have a continuous or variable cross section. Depending on the depth of the particular application and the conditions to which the collector system 400 will be exposed, the wings 402 and the holding tank 404 can comprise metal, PVC, or any other suitable material. By such a configuration, the collection system 400 can serve the dual functions of collecting permeate and providing the system with structural reinforcement against environmental conditions.

FIG. 17A shows a partially cut away perspective view of a membrane module comprising a number of membrane cartridges 432 attached to a collection system 430. One of the cartridges 432 has been removed to better illustrate portions of the collection system 430. An end portion of the collection system 430 has also been removed to illustrate an interior channel 431 of the collection system. The collection system 430 has a top portion 434 and a bottom portion 436, and is reinforced by struts 440 extending between the top and bottom portions 434, 436. The membrane cartridges 432 are placed with their front walls 433 (see FIGS. 9A through 9F) in abutting relationship with the collection system 430, on either side of the system 430. Dowels 438 on the front ends of the cartridges 432 sit against the struts 440, allowing the free flow of permeate around the struts 440. The area between the front walls 433 of the cartridges 432 and the top and bottom portions 434, 436 of the collection system 430 is enclosed to separate the permeate side of the membranes from the ambient source water. The top and bottom portions 434, 436 are perforated to receive permeate flowing from the cartridges 432 into the interior channel 431 of the collection system 430. The permeate side of the membranes is kept at about atmospheric pressure by a breathing tube (not shown) in fluid communication with the collection system 430.

When the membrane module is submerged, ambient source water flows substantially freely through the top, bottom, and rear of each cartridge 432. The pressure differential between the source water side of the membranes and the permeate side of the membranes causes permeate to flow to the low pressure (permeate) side of the membranes. Although illustrated in a generally symmetrical configuration with cartridges on either side of a collection system, membrane modules can be configured in any other suitable configuration.

FIG. 17B shows a perspective view (not to scale) of a membrane module 450 configured according to another embodiment. The module 450 includes a number of cartridges 452 attached to a collection framework 451 comprising various interconnected pipes. The collection framework 451 includes four columns 454 situated at the corners of the framework 451. The columns 454 comprise vertically oriented pipes which are connected at two opposing sides of the framework 451 by one or more end pipes 456. At the other two sides of the framework 451, the columns 454 are connected by one or more collection channels 458. The illustrated embodiment includes two upper and two lower collection channels 458, each channel 458 having a top section 460(a) and a bottom section 460(b). Each collection channel 458 is configured to support a set of cartridges 452 and receive permeate flowing through the front walls of the cartridges 452 (that is, the ends of the cartridges abutting the collection channel 458), while preventing the flow of source water into the collection channel 458. Each collection channel 458 can include end plates 462 or other features configured to separate the permeate side of the membranes in the cartridges 452 from the ambient source water. The permeate side of the membranes is kept at about atmospheric pressure by a breathing tube (not shown) in fluid communication with the collection framework 451. The collection channels 458 can be configured substantially as described above in connection with FIG. 17A, or can have any other configuration suitable for their intended purpose. By employing such a system of interconnected pipes, the collection framework 451 can serve the dual functions of storing permeate and providing the system with structural reinforcement against environmental conditions. One or more pumps (not shown) can be provided in one or more of the columns 454, or anywhere else in the system, to pump the collected permeate to the surface.

The framework 451 can also include one or more reinforcing members 464 configured to provide additional structural support to the module 450. The reinforcing members 464 can be disposed between the columns 454 and the end pipes 456, as shown in the figure. Additionally or alternatively, reinforcing members can be disposed between the end pipes 456 and the collection channels 458, between two or more columns 454, between two or more collection channels 458, and/or in any other suitable configuration. The reinforcing members can comprise solid members, or can comprise hollow pipes to form part of the collection system and provide additional storage within the system. A walkway 466 can optionally be attached at the center of the framework 451 to provide access during construction and maintenance of the module 450.

FIG. 18 shows a basic diagram (not to scale) depicting a top view of a DEMWAX™ plant including an offshore platform 500 and several submerged membrane modules 502. The modules 502 are configured in different banks and connected to a permeate collector line 503. The platform can support the equipment for operation of the system (power generation, pumping, etc.).

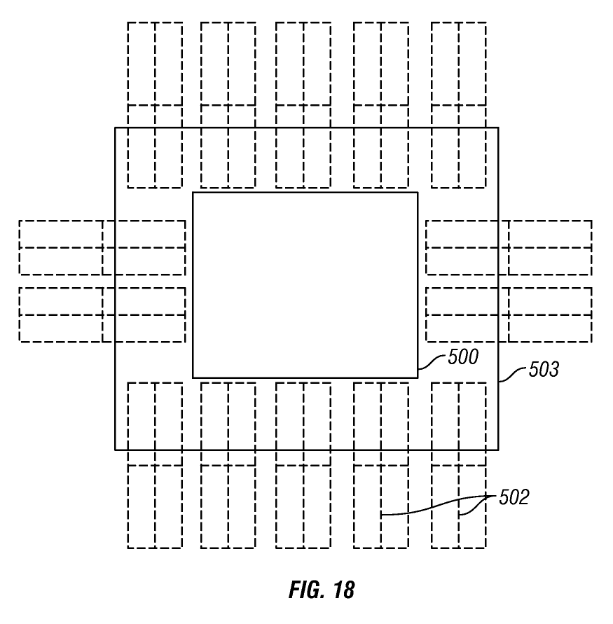

FIG. 19 shows a basic diagram (not to scale) depicting a top view of submerged DEMWAX™ modules 504 arranged in parallel and serial configurations.

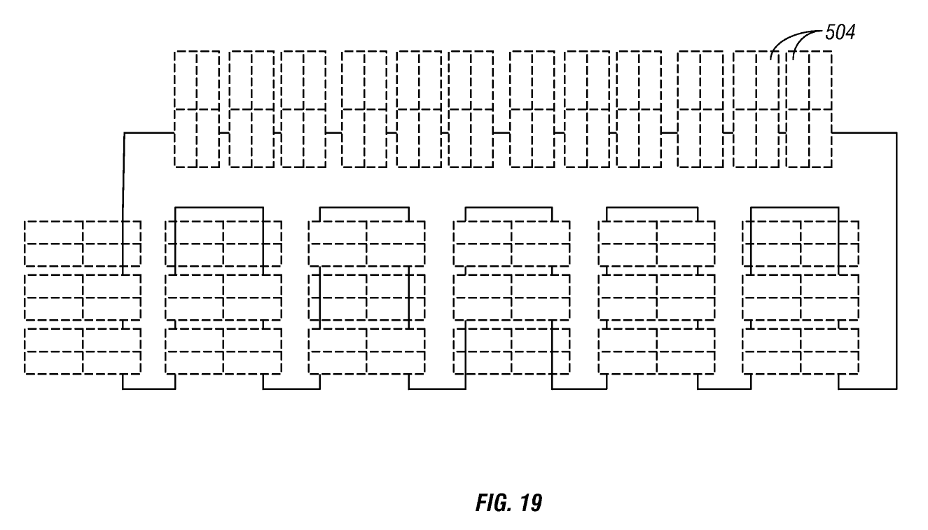

FIG. 20 shows a plan view of an array system of buoys 506 supporting DEMWAX™ modules 508. Power cables connect the buoy/module stations to a power generation platform 510, and water pipes connect the collection systems of each buoy/module station to offshore or onshore storage.

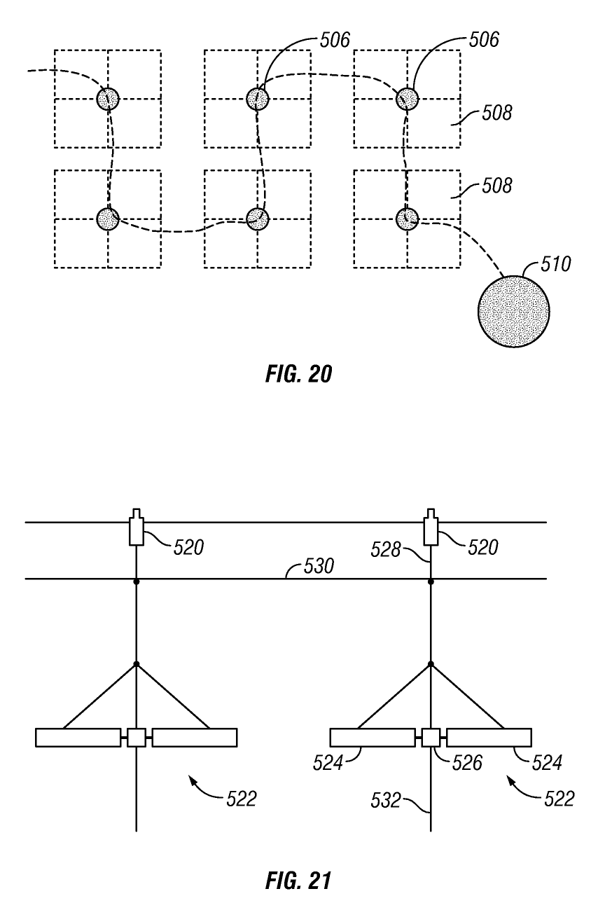

FIG. 21 shows a side view of array system configuration of buoys 520 supporting DEMWAX™ modules 522. Each module 522 includes one or more membrane modules 524 fluidly connected to a collector system 526. The collector system 526 is exposed to atmospheric pressure via a breathing tube 528. Power cables and permeate pipes 530 (situated deep enough to avoid surface traffic) connect the buoy/module stations to offshore or onshore power generation and water storage. Each buoy/module station is anchored to the ocean floor by a tether 532.

To minimize the footprint of multi-bank arrays, banks of modules can be stacked on top of one another in layers. The layers can be vertically spaced to allow for mixing to occur between the heavier concentrate falling from the membrane modules of an upper layer and the ambient seawater. Any suitable configuration can be employed, and banks of modules can be added or removed as desired, e.g., to increase or decrease permeate production, to replace damaged modules, to clean modules, or to break down part of the system for transport elsewhere.

### Reverse Osmosis Membrane Systems and Configurations

As discussed above, any suitable configuration can be employed for the reverse osmosis membranes used in the systems of preferred embodiments. These include loose spiral-wound configurations, wherein flat sheet membranes are wrapped around a center collection pipe. The density of such systems is typically from about 200 to 1,000 m²/m³. Module diameters typically are up to 40 cm or more. Feed flows axially on a cylindrical module and permeate flows into the central pipe. Spiral wound systems exhibit high pressure durability, are compact, exhibit a low permeate pressure drop and low membrane concentration, and exhibit a minimum concentration polarization. Preferably, the spiral wound modules are situated in a vertical configuration, to facilitate transfer of denser concentrate away from the membrane surfaces.

Another configuration that can be employed in systems of preferred embodiments is commonly referred to as plate and frame. Membrane sheets are placed in a sandwich style configuration with feed sides facing each other. Feed flows from the sides of the sandwich and permeate is collected from the frame (e.g., on one or more sides). The membranes are typically held apart by a corrugated spacer. The density is typically from about 100 to about 400 m²/m³. Such configurations are advantageous in that the structure and membrane replacement are relatively simple. In a plate and frame configuration, as in other configurations, the membranes are preferably spaced sufficiently far apart such that surface tension does not interfere with convection currents transferring the more dense concentrate down and away from the membrane surface.

Another membrane type that can advantageously be employed in systems of preferred embodiments is a hollow fiber membrane. A large number of these hollow fibers, e.g., hundreds or thousands, are bundled together and housed in modules. In operation, pressure at depth is applied to the exterior of the fibers, forcing potable water into the central channel, or lumen, of each of the fibers while dissolved ions remain outside. The potable water collects inside the fibers and is drawn off through the ends.

The fiber module configuration is a highly desirable one as it enables the modules to achieve a very high surface area per unit volume. The density is typically up to about 30,000 m²/m³. The fibers are typically arranged in bundles or loops which are potted on the ends, with the ends of fibers open on one end to withdraw permeate. The packing density of the fiber membranes in a membrane module is defined as the cross-sectional potted area taken up by the fiber. In preferred embodiments, the membranes are in a spaced apart (e.g., at low packing densities), for example, a spacing between fiber walls of from about 1 mm or less to about 10 mm or more is typically employed.

Typically, the fibers within the module have a packing density (as defined above) of from about 5% or less to about 75% or more, preferably from about 10% to about 60%, and more preferably from about 20% to about 50%. Any suitable inner diameter can be employed for the fibers of preferred embodiments. Due to the high pressures at depth that the fibers are exposed to, it is preferred to employ a small inner diameter for greater structural integrity, e.g., from about 0.05 mm or less to about 1 mm or more, preferably from about 0.10, 0.20, 0.30, 0.40, or 0.50 mm to about 0.6, 0.7, 0.8, or 0.9 mm. The fiber's wall thickness can be selected based on balancing materials used and strength required with filtration efficiency. Typically, a wall thickness of from about 0.1 mm or less to about 3 mm or more, preferably from about 1.1, 1.2, 1.3, 1.4, 1.5, 1.6, 1.7, 1.8, or 1.9 mm to about 2.0, 2.1, 2.2, 2.3, 2.4, 2.5, 2.6, 2.7, 2.8, or 2.9 mm can be employed in certain embodiments. It can be desirable to employ a porous support or packing material in the fiber, e.g., when the fibers have a relatively large diameter or a relatively thin wall, to prevent collapse under pressure at depth. A preferred support is cellulose acetate; however, any suitable support can be employed.

The length of the fibers is preferably relatively short, to overcome the resistance to flow. If exposed to relatively fast-moving currents, then longer fibers can be employed.

In certain embodiments, it can be advantageous to provide a source of aeration and/or liquid flow (e.g., pressurized water, or pressurized water containing entrained air) to the membrane module beneath the fibers, such that bubbles or liquid can pass along the exterior of the fibers to provide a scrubbing action to reduce fouling and increase membrane life, or to reduce concentration polarization at the membrane surface. Similarly, the membranes can be vibrated (e.g., mechanically) to produce a similar effect. It is generally preferred to allow the membranes to function under ambient conditions without introducing mechanically generated currents or flow into the membranes (e.g., fibers or sheets), so as to minimize energy consumption. However, in certain embodiments (e.g., water with a high degree of turbidity or organics content) it can be desirable to provide such currents or flow so as to increase membrane life by reducing fouling.

The fibers are preferably arranged in cylindrical arrays or bundles, however other configurations can also be employed, e.g., square, hexagonal, triangular, irregular, and the like. It is preferred that the membranes are maintained in an open spaced apart configuration so as to facilitate the flow of seawater and concentrate therethrough; however, in certain embodiments it can be desirable to bundle together fibers or groups of fibers, to partition the fibers, or to enclose the fibers within a protective screen, cage or other configuration to protect the membranes from mechanical forces (e.g., during handling) and to maintain their spacing. Preferably, the partitions or spacers are formed by a spacing between respective fiber groups, however porous (e.g., a screen, clip, or ring) or solid partitions or spacers can also be employed. The fiber bundles can be protected by a support screen which has both vertical and horizontal elements appropriately spaced to provide unrestricted seawater flow around the fibers.

In certain preferred embodiments, it can be desirable to enclose the membranes within a vessel or other enclosure, which can provide protection against mechanical forces (e.g., as in a conventional spiral-wound membrane encased within a protective tube), and to continuously or intermittently introduce seawater into (and remove concentrated brine from) the vessel containing the membranes. However, it is generally preferred to have the membranes either partially or wholly uncontained so that they are directly exposed to ambient source water.

The membranes of any particular configuration (sheet, spiral wound, or fiber) are advantageously provided in cartridge form. The cartridge form permits a desired number of cartridges to be joined to a permeate withdrawal system so as to generate the desired volume of permeate. A cartridge system is also advantageous in facilitating removal and replacement of a cartridge with fouled or leaking membranes.

Over time the membrane's efficiency decreases due to adsorption of impurities on the membrane surface. Scaling reduces efficiency of membranes by suspended inorganic particles, such as calcium carbonate, barium sulfate and iron compounds blocking filtration capacity and/or increasing operation pressure. Fouling occurs when organic, colloidal and suspended particles block filtration capacity. Membranes can be cleaned using conventional anti-scalants and anti-foulants to regenerate filtration capacity and increase membrane life. Physical cleaning methods, such as backwashing, can also be effective in regenerating a membrane to increase membrane life. In backwashing, permeate is forced back through the membrane. The membranes employed in the systems of preferred embodiments can be placed on a regular cleaning schedule for preventative maintenance, or a regular membrane replacement schedule. Alternatively, systems can be employed to detect when cleaning or replacement is necessary (e.g., when permeate flow rate decreases by a preselected amount, or when pressure necessary to maintain a permeate flow rate increases to a preselected amount).

### Support Structure

Offshore platforms suitable for use with the systems of preferred embodiments include those typically employed in offshore oil drilling and oil production. Fixed offshore platforms are constructed in an assortment of structural configurations, and include any structure founded on the seafloor and extending from the seafloor through the water surface. The portion of the platform housing equipment supporting the desalination process is typically referred to as the platform topsides or deck. The portion of the platform extending from the seafloor through the water surface and supporting the topsides is typically of a type referred to as a jacket (tubular space frame), guyed platform, or tension leg platform. Platforms include tension leg platforms wherein a floating platform is connected to the ocean floor via tendons such as steel cables.

Another type of floating platform is the spar platform which generally is a floating cylindrical structure that is anchored to the ocean floor with steel cables. The platform can be rigid, or include articulation of a rigidly framed structure. Guyed platforms are typically supported vertically and laterally at the base while free to rotate out of vertical about the base. Stability is supplied to the platform by an array of guy lines attached towards the platform top and anchored to the seafloor some distance away from the platform base. The platform is restored to a vertical position after being deflected horizontally by tension forces within the attached guys. Gravity based structures are large structures designed to be towed to the installation location, where they are ballasted down and held in place on the sea floor by the force of gravity. Gravity based structures have a large capacity for carrying large deck payloads during the ocean tow to the installation site, and decks are transferred to the structure once it is in place. Other platforms, commonly referred to as semi-submersible platforms, include generally rectangular or cylindrical pontoons, often in excess of 20,000 tons displacement, that provide stability during extreme weather events.

Alternatively, a vessel can be used to support the systems of preferred embodiments, e.g., a barge, tanker, or a spar platform. Spar platforms generally have an elongated caisson hull having an extremely deep keel draft, typically greater than 500 feet. The spar supports an upper deck above the ocean surface and is moored using catenary anchor lines attached to the hull and to seabed anchors. Risers generally extend down from a moon pool in the hull of the spar platform to the ocean floor. The hull of the typical spar platform is generally cylindrically shaped, typically formed of a large series of curved plates positioned in a circular fashion and having a perpendicular radial plane which passes through the isocenter of the hull to form a cylindrical structure. This cylindrical design is used to reduce the severity of the shedding of vortices caused by the ocean currents and to more efficiently resist the hydrostatic pressures.

In shallower water, sea floor supported platforms can advantageously be used. Platforms located in shallower waters are designed for static wind and wave loadings.

In another configuration, a buoyant structure such as a balloon (e.g., a concrete shell enclosing air, or other such configuration) can be employed to suspend a DEMWAX™ module above at depth. The buoyant structure can be tethered to the ocean floor, or can be equipped with a propulsion device to maintain the module at a desired location (depth and/or latitude and longitude). In such a configuration, the buoyant structure can be at the surface, or submerged. If the buoyant structure is submerged, a buoy or other surface structure can be employed to support a breathing tube, if present. Buoyant structures can be employed to support any other component(s) of the system, as desired, or can be used in combination with other supporting systems. A system of buoys to support DEMWAX™ modules is depicted in FIGS. 20 and 21.

A deck structure can be provided to support personnel and equipment for operation of the systems of preferred embodiments (e.g., electrical power generators or engine-driven hydraulic motors, pumps, crew housing, etc.). Offshore platforms can be either manned, or (preferably) unmanned. Unmanned offshore platforms require periodic maintenance; however, for which purpose a maintenance crew has to visit the platform to carry out the necessary maintenance work. Access to offshore platforms can be provided, e.g., by helicopter or ship. Accordingly, it can be advantageous to provide the platform with a helideck or other structures supporting transfer of crew and equipment on and off the platform. Energy generators, such as electrical power generators or engine-driven hydraulic motors, can be provided on board the platform for use when maintenance is to be carried out. This also adds to the cost of the platform where such generators or motors for maintenance use are permanently installed on the platform. If instead they are transported in the support craft, this is inconvenient for the crew, particularly when transporting such equipment from the craft to the platform. In certain embodiments, it can be desired to generate power at depth (e.g., submarine power generation). In such a configuration, it can be desired to situate all components except for the breathing tube (if employed) at depth.

In an alternative configuration, a single DEMWAX™ module or small group of modules can be suspended from a buoy or tethered directly to the bottom. Several such modules can be strung together to yield a larger plant, which can eliminate the need for a large platform in those areas where a platform is undesirable (e.g., for reasons of esthetics, or environmental impact). The buoy unit can incorporate a small generator and fuel tank, or an underwater transmission cable. Alternatively, a larger buoy or small platform or the like can be employed to house power generation for several smaller buoys with DEMWAX™ modules suspended from them. In a preferred configuration, the buoys are situated around a permeate storage tank or structure.

Membrane collection systems of preferred embodiments can be employed in any suitable configuration, for example, in a concentric circle configuration, or other configurations (e.g., a ‘closest packed’ hexagonal configuration, concentric octagonal arrays with eight trapezoidal membrane modules feeding into radial collectors, or a series of collectors in any configuration that feed into a central collector. In addition to horizontally spaced arrays or modules, vertically spaced arrays or modules can also be employed.

### Alternative Power Supplies

Because the DEMWAX™ system has much lower energy requirements than conventional desalination systems, it is particularly suitable for integration with renewable power resources such as wind generators or solar photovoltaic to serve small, remote water loads. Likewise, if the DEMWAX™ system is situated in an area that experiences very high and very low tides, tidal energy can be advantageously employed to generate power for the system. If local, abundant, and/or low cost fuel sources are available (e.g., biodiesel, methane, natural gas, biogas, ethanol, methanol, diesel, gasoline, bunker fuel, coal, or other hydrocarbonaceous fuels), it can be desirable to select power generators that can take advantage of these fuel sources. Alternatively, if electricity is conveniently available from an onshore site, a power cable to the DEMWAX™ platform can be provided for power needs. Other energy generation systems can include wave surge and tidal surge systems, or nuclear (land-based or submarine).

### Alternative Embodiments

Although described herein above with particular reference to reverse osmosis membranes and ocean desalination applications, embodiments can be used to advantage with other types of membranes and in numerous other applications, for example as described below.

### Freshwater Applications

Water from lakes, reservoirs and rivers accrues contamination from sources such as wildlife, urban runoff and organic growth. The most common method of treatment is a three-step process including chemical enhanced clarification, filtration, and disinfection. The conventional clarification process typically uses costly chemicals to coagulate the organic contaminants producing a sludge that must be disposed to a landfill. Sand or membrane filtration steps are capital and space intensive. Embodiments of the DEMWAX™ system can be used to advantage to replace the first two of these processes more efficiently than conventional systems, with no chemicals, with reduced complexity, at far less capital cost, and with better product water quality, by using the natural pressure exerted by the water column in a body of water to drive the treatment process.

Systems of preferred embodiments adapted for treating surface water for potable uses typically utilize membrane modules including nanofiltration membrane units. The smaller pore size of nanofiltration membranes produces water that far exceeds current EPA surface water treatment requirements, and the low flux (˜5 to 10 gfd) makes maintenance simpler as the impurities do not readily attach to the smaller pores of the nanofiltration membrane as compared to currently-available microfiltration (MF) membrane systems. When microfiltration membranes are employed instead of nanofiltration membranes, silts can be lodged in their larger pores requiring much more comprehensive and frequent cleaning. DEMWAX™ systems of preferred embodiments reduce or eliminate the requirement of frequent backwashing and its attendant complexities (valves and pumps). The maintenance regimen for microfiltration systems therefore requires more complex systems and hardware. The nanofiltration systems of preferred embodiments have a low maintenance barrier and keep microbes, viruses, organics, and other unwanted constituents out of the water supply. By lowering the membrane modules to a depth of from about 6 meters to about 200 meters, depending on the precise membrane and source water quality, the water is naturally at high enough continuous pressure to drive the filter process. Of course, embodiments using reverse osmosis membranes can also be used in freshwater applications. For example, embodiments using reverse osmosis membranes can be deployed at about 15 meters of depth (or deeper) and used to produce ultrapure water.

Systems of preferred embodiments adapted for use in freshwater applications can be configured essentially as described above in connection with ocean applications, for example with one or more membrane modules and a collection system suspended at depth, and a breathing tube extending upward from the collection system to the surface. Certain systems of preferred embodiments can be anchored to the bottom of the body of water via one or more tethers, although tethering is not a requirement unless the system is buoyant.

Membrane modules of preferred embodiments can include one or more membrane units, and can be configured in any suitable fashion allowing the source water to flow substantially freely in the spaces between the membrane units. The spacing algorithm described for ocean applications is modified slightly for freshwater treatment applications. In freshwater applications, the limiting factor in the spacing between the membrane units is surface tension. As dissolved solids are generally not present in high concentrations in surface water sources, overcoming osmotic pressure does not require the high pressures associated with desalination. As such, slightly concentrating feed water may not raise the pressure requirements if spacing is insufficient, unlike in seawater applications. Accordingly, systems of preferred embodiments adapted for use with freshwater applications can utilize a narrower spacing (about 3 millimeters or about ⅛ inch spacing) than is typically employed in seawater applications.

Each membrane element can include two membrane sheets with a separator (e.g., polymer, composite, metal, etc.) disposed between the two layers, to allow the permeate (treated potable water) to flow between them. The two plies can be rectangular sheets of membrane that filter out the impurities and pass the clean water through the separator to a collector. The membrane layers and separator layer can be joined and sealed at the edges on the sides with a passageway or other opening provided to remove permeate. Preferably, they are joined on three sides, with the fourth side as the opening provided to remove permeate. The open (unsealed) edge or unsealed portion of an edge is placed in fluid communication with the collection system. The collection system can include a collection channel adapted to provide structural support to the system. Waves and currents are not present to the same extent in freshwater applications as in ocean applications, and appropriate materials and structure can be selected with this in mind.

The collection system preferably contains a submersible pump, and is connected to two pipes (or tubes, passageways, openings, or other flow directing means): one through which the permeate is pumped to the shore, and a pipe or breathing tube adapted to communicate atmospheric pressure from the surface of the body of water to the treated water side of the membranes, thereby providing the necessary pressure differential to drive the treatment process. The diameter of the breathing tube is selected to avoid the occurrence of air binding or excessive velocity during pump operation. From the collection system, the permeate is pumped to the final treatment facility. In many freshwater applications, the pumping distance to shore is typically relatively short, as many reservoirs and lakes have at least 6 meters of depth rather close to the shore.

Storage can be provided within the system or onshore to buffer the continuous filtration process against the uneven hourly demand for water. For example, temporary storage can be provided within a collection channel or system as described above in connection with FIG. 16. Additionally or alternatively, embodiments can create virtual water storage by placing the membranes at greater depths, where higher flux rates can be induced by turning on more pump capacity. When the membrane modules are submerged to a greater depth than required for the base load design capacity, the constant base load pumping speed induces backpressure in the system because the membranes is producing more water than the pump can vacate. In times of high demand, increasing the flow rate of the permeate pumps lessens the back-pressure in the system, increasing the pressure differential across the membranes and increasing permeate production rates.

In freshwater applications, accumulation of organic growth such as algae can impede water production and necessitate periodic cleaning. Accordingly, systems of preferred embodiments can be designed to loosen the algae and other contaminants from the membranes. Automatic systems can be provided which force compressed air or water through an array of nozzles located below the membranes. Fiber agitators can also be provided which assist in loosening any solids from the membrane face. Such cleaning systems can be deployed at daily intervals, and can be supplemented with a more thorough bi-annual, or as necessary, cleaning process that involves removing the membrane cartridges from the water. As such, systems of preferred embodiments can include an automated system for raising and lowering the modules, e.g., through the use of ballast tanks, or the like.

Power is transmitted to the DEMWAX™ system to pump the product water. There are many ways to accomplish this and the method selected can depend on the size of the system and the availability of power near the unit. Considerations for the power provision include the distance the site is from the shore (line losses and cabling costs) as well as the intrusion (visual and navigational) of power located on the surface of the water source (floating on a buoy).

### Groundwater Applications

Heavy metal and volatile organic compounds often contaminate groundwater supplies. Conventional methods of removal are expensive and require disposal of the resulting toxic waste, with attendant liabilities. DEMWAX™ systems of preferred embodiments can be advantageously used to produce clean water from contaminated wells for which other types of treatment might be cost-prohibitive.

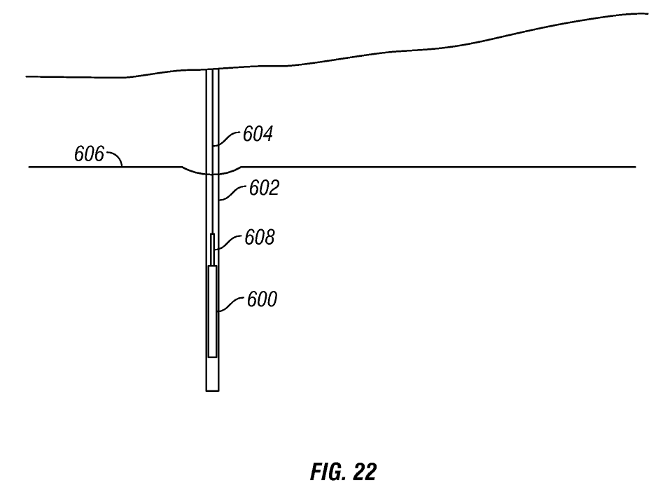

FIG. 22 illustrates an example of a DEMWAX™ system adapted for use in groundwater applications. The system includes a cylindrical membrane cartridge 600 comprising one or more nanofiltration membranes, submerged in an existing well 602. The membranes surround a central collection chamber, with the permeate side of the membranes in fluid communication with the chamber. The chamber is maintained at atmospheric pressure by a breathing tube 604 which extends to at least the top of the water table 606, which, as shown in the figure, may be drawn down somewhat in the region of the well 602. By submerging the cartridge 600 below the well pump 608 to a depth of about 33 feet (10 meters) below the top of the water table 606, clean water can be produced and pumped out of the well 602, leaving the contaminants in the ground. Movement and recharge of underground aquifers can keep these contaminants from building up in the area around the well.

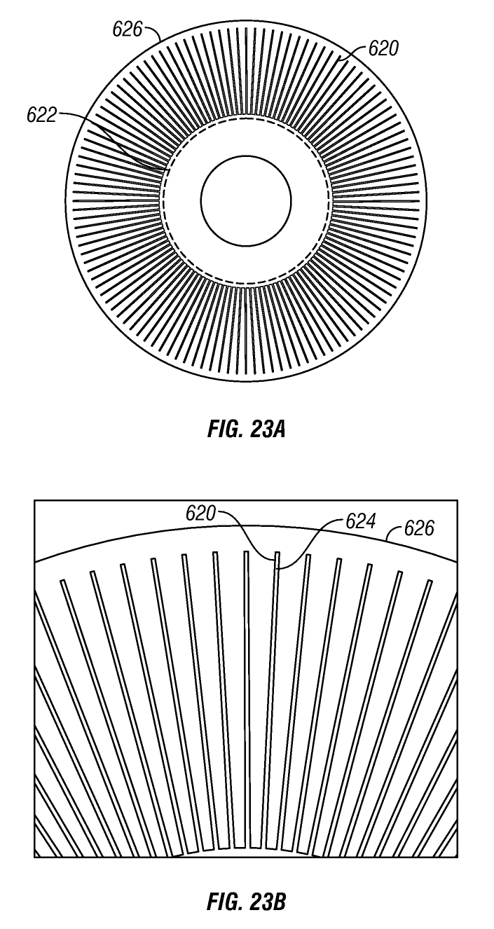

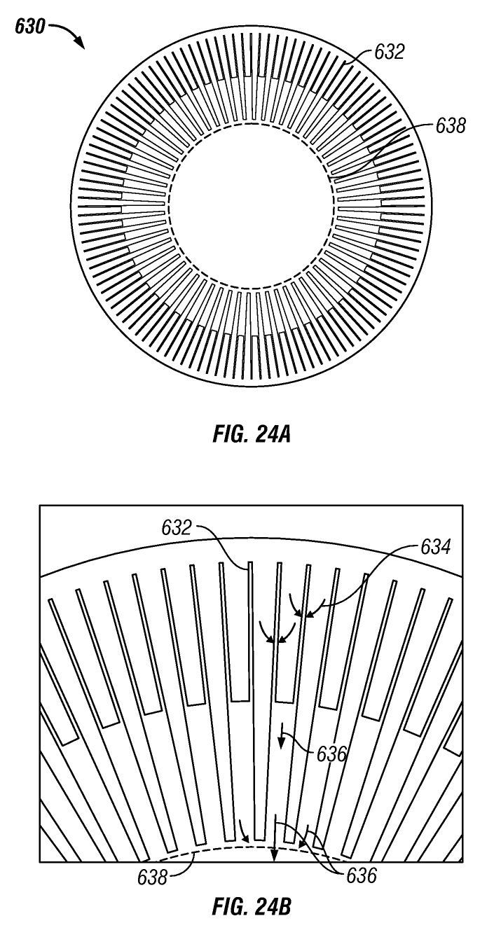

FIGS. 23A-23B and 24A-24B illustrate various configurations of a cylindrical membrane cartridge adapted for groundwater applications. A cylindrical membrane cartridge typically includes a membrane surrounding a central collection channel. In preferred embodiments, the membrane is configured in such a way as to maximize the membrane surface area within the cylindrical constraint of a groundwell. For example, as illustrated in FIGS. 23A and 23B, a membrane 620 is arranged in an accordion fold in a cylindrical configuration around a central collection channel 622. One or more permeate spacers 624 are disposed inside each fold, either continuously or at discrete locations, to prevent the membrane folds from collapsing on themselves. The dashed line in the figure indicates perforations in the central collection channel 622, which are provided to allow the passage of permeate through the spacers 624 and into the channel 622. When submerged in a well casing 626, the outer surfaces of the membrane 620 are exposed to ambient groundwater in the well, so that permeate can pass through to the central collection channel 622. A frame (not shown), for example comprising ribs and struts, can optionally be provided around the folded membrane to provide structural support for the system. Systems employing multiple cartridges in a stacked configuration can include a connector pipe 628 to connect the collection channels 622 of each cartridge. In some embodiments, as shown in FIGS. 24A and 24B, a cylindrical cartridge 630 can include a membrane 632 with folds that double back on each other at the outer circumference of the cylinder so as to maintain similar spacing between the folds from the center of the cartridge to the periphery. The folded membrane 632 surrounds a perforated central collection channel 638. The flow of source water against the membranes 632 is indicated by arrows 634. The flow of permeate into the collection channel 638 is indicated by arrows 636. In embodiments configured for groundwater applications, the membrane folds can be spaced closer together than in seawater applications; but preferably not so close that surface tension inhibits the flow of feed water between the membranes.

Apparatus and methods suitable for use in connection with the systems of preferred embodiments are described in the following references, each of which is incorporated by reference herein in its entirety: Pacenti et al., “Submarine seawater reverse osmosis desalination system”, Desalination 126 (1999) 213-218; U.S. Pat. No. 5,229,005; U.S. Pat. No. 3,060,119; Colombo et al., “An energy-efficient submarine desalination plant”, Desalination 122 (1999) 171-176; U.S. Pat. No. 6,656,352; U.S. Pat. No. 5,366,635; U.S. Pat. No. 4,770,775; U.S. Pat. No. 3,456,802; and U.S. Patent Publication No. US-2004-0108272-A1.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A filtration system, the system comprising:
a membrane module configured to be submerged in a body of water at a submerged depth, the membrane module comprising at least one membrane cartridge, the membrane cartridge comprising at least one membrane element, the membrane element having a first side and a second side, wherein the first side of the membrane element is exposed to the water to be filtered at a pressure characteristic of the submerged depth;
a collector passageway configured to be submerged in the body of water, wherein at least a portion of the collector passageway is in fluid communication with the second side of the membrane element where filtered water is collected; and
a breathing passageway extending from the collector passageway to a surface of the body of water and configured to expose an interior of the collector passageway to a pressure characteristic of atmospheric pressure at the surface of the body of water or at an elevation higher than the surface of the body of water, wherein a differential between the pressure characteristic of the submerged depth and the pressure characteristic of atmospheric pressure at the surface of the body of water or at an elevation higher than the surface of the body of water causes permeate to flow from the first side of the membrane element to the second side of the membrane element.

2. The water treatment system of claim 1, wherein the membrane element comprises two membrane layers spaced apart by at least one permeate spacer.

3. The water treatment system of claim 1, wherein the membrane element is substantially planar.

4. The water treatment system of claim 1, wherein the membrane cartridge comprises at least two membrane elements.

5. The water treatment system of claim 4, comprising a plurality of membrane elements, wherein each membrane element is spaced apart from an adjacent membrane element by at least about 1 mm.

6. The water treatment system of claim 4, comprising a plurality of membrane elements, wherein each membrane element is spaced apart from an adjacent membrane element by at least about 2 mm.

7. The water treatment system of claim 4, comprising a plurality of membrane elements, wherein each membrane element is spaced apart from an adjacent membrane element by from about 2 mm to about 8 mm.

8. The water treatment system of claim 4, comprising a plurality of membrane elements, wherein each membrane element is spaced apart from an adjacent membrane element by about 6 mm.

9. The water treatment system of claim 4, wherein the membrane element comprises two flat sheet membranes in a parallel configuration, the membrane element further comprising at least one collector spacer situated between two flat sheet membranes, wherein the collector spacer is configured to separate the two flat sheet membranes from each other.

10. The water treatment system of claim 1, wherein the membrane module comprises a plurality of the membrane cartridges.

11. The water treatment system of claim 1, wherein the membrane element comprises at least one nanofiltration membrane.

12. The water treatment system of claim 11, wherein the membrane module is configured to be submerged to a depth of at least about 6 meters.

13. The water treatment system of claim 11, wherein the membrane module is configured to be submerged to a depth of at least about 8 meters.

14. The water treatment system of claim 11, wherein the membrane module is configured to be submerged to a depth of at least about 10 meters.

15. The water treatment system of claim 11, wherein the membrane module is configured to be submerged to a depth of from about 12 meters to about 18 meters.

16. The water treatment system of claim 11, wherein the membrane module is configured to be submerged to a depth of at least about 30 meters.

17. The water treatment system of claim 11, wherein the membrane module is configured to be submerged to a depth of at least about 60 meters.

18. The water treatment system of claim 11, wherein the membrane module is configured to be submerged to a depth of about 60 meters.

19. The water treatment system of claim 11, wherein the membrane module is configured to be submerged to a depth of from about 60 meters to about 244 meters.

20. The water treatment system of claim 11, wherein the membrane module is configured to be submerged to a depth of from about 122 meters to about 152 meters.

21. The water treatment system of claim 11, wherein the membrane module is configured to be submerged to a depth of from about 152 meters to about 183 meters.

22. The water treatment system of claim 1, wherein the membrane element comprises at least one reverse osmosis membrane.

23. The water treatment system of claim 22, wherein the membrane module is configured to be submerged to a depth of at least about 190 meters.

24. The water treatment system of claim 22, wherein the membrane module is configured to be submerged to a depth of at least about 244 meters.

25. The water treatment system of claim 22, wherein the membrane module is configured to be submerged to a depth of from about 259 meters to about 274 meters.

26. The water treatment system of claim 1, wherein the membrane element comprises at least one ultrafiltration membrane.

27. The water treatment system of claim 26, wherein the membrane module is configured to be submerged to a depth of at least about 6 meters.

28. The water treatment system of claim 26, wherein the membrane module is configured to be submerged to a depth of at least about 8 meters.

29. The water treatment system of claim 26, wherein the membrane module is configured to be submerged to a depth of at least about 10 meters.

30. The water treatment system of claim 26, wherein the membrane module is configured to be submerged to a depth of from about 12 meters to about 18 meters.

31. The water treatment system of claim 26, wherein the membrane module is configured to be submerged to a depth of at least about 22 meters.

32. The water treatment system of claim 26, wherein the membrane module is configured to be submerged to a depth of from about 22 meters to about 60 meters.

33. The water treatment system of claim 1, wherein the membrane element comprises at least one microfiltration membrane.

34. The water treatment system of claim 33, wherein the membrane module is configured to be submerged to a depth of at least about 6 meters.

35. The water treatment system of claim 33, wherein the membrane module is configured to be submerged to a depth of at least about 8 meters.

36. The water treatment system of claim 33, wherein the membrane module is configured to be submerged to a depth of at least about 10 meters.

37. The water treatment system of claim 33, wherein the membrane module is configured to be submerged to a depth of from about 12 meters to about 18 meters.

38. The water treatment system of claim 1, wherein the membrane module is configured to be submerged to a depth of at least about 7 meters, and is further configured to substantially avoid entrainment of aquatic life as permeate passes from the first side of the membrane element to the second side of the membrane element.

39. The water treatment system of claim 1, wherein the differential between the pressure characteristic of the submerged depth and the pressure characteristic of atmospheric pressure at the surface of the body of water provides substantially all of the force driving the filtration process, in the absence of a mechanical device to increase the pressure to which the first side of the membrane is exposed, and in the absence of a mechanical device to reduce the pressure to which the second side of the membrane is exposed.

40. A water treatment system comprising:
at least one membrane configured to be submerged to a depth in a body of water to be treated, the water having a first pressure at the submerged depth, the membrane having a concentrate side and a permeate side;
a collector in fluid communication with the permeate side of the membrane; and
a passageway configured to expose an interior of the collector to a second pressure which is lower than the first pressure, wherein exposing the concentrate side of the membrane to the first pressure drives a filtration process in which permeate moves across the membrane from the concentrate side to the permeate side.

41. The water treatment system of claim 40, wherein the second pressure is characteristic of atmospheric pressure at the surface of the body of water.

42. The water treatment system of claim 40, wherein the passageway extends from the collector to at least the surface of the body of water.

43. The water treatment system of claim 40, wherein the collector is the passageway.

44. A water treatment system comprising:
means for screening out at least one constituent from a source water to produce a product water, the screening means having a source water side and a product water side, wherein the source water side is configured to be exposed to a hydrostatic pressure of the source water; and
means for collecting the product water, wherein the collecting means is configured to be exposed to a pressure lower than the hydrostatic pressure.

45. The water treatment system of claim 44, wherein the lower pressure is characteristic of atmospheric pressure at the surface of the source water.

46. A water treatment system comprising:
means for filtering a source water to produce a product water, the filtering means having a source water side and a product water side; and
means for taking advantage of ambient pressure conditions in the source water and above the source water to create a pressure differential between the source water side and the product water side sufficient to induce permeate to cross from the source water side to the product water side.

47. A filtration system for producing product water from feed water, the system comprising:
at least one reverse osmosis membrane, wherein the membrane is configured to permit passage of water therethrough while restricting passage therethrough of one or more ions dissolved in the feed water, wherein the membrane is configured to be submerged at a depth in a body of feed water containing the ions dissolved therein, wherein the depth is at least about 141 meters, wherein a first side of each of the membranes is configured to be exposed to the feed water at a pressure characteristic of the submerged depth, and wherein a collector on a second side of each of the membranes is configured to be exposed to a pressure characteristic of atmospheric pressure at sea level, whereby, in use, a pressure differential across each of the membranes drives a reverse osmosis filtration process such that a permeate of a reduced dissolved ion concentration is obtained on the second side of each of the membranes, wherein the membrane is situated such that, in use, at least one of gravity and current effectively removes a higher density concentrate away from the membrane.

48. The system of claim 47, wherein the system is configured to be submerged in a body of seawater to a depth of from about 113 meters to about 307 meters, wherein the seawater has a salinity of from about 20,000 to about 42,000 ppm.

49. The system of claim 47, wherein the system is configured to be submerged in a body of seawater to a depth of from about 247 meters to about 274 meters, wherein the seawater has a salinity of from about 33,000 to about 38,000 ppm.

50. The system of claim 47, comprising a plurality of membranes, wherein each membrane is spaced apart from an adjacent membrane by at least about 1 mm.

51. The system of claim 47, comprising a plurality of membranes, wherein each membrane is spaced apart from an adjacent membrane by at least about 2 mm.

52. The system of claim 47, comprising a plurality of membranes, wherein each membrane is spaced apart from an adjacent membrane by from about 2 mm to about 8 mm.

53. The system of claim 47, comprising a plurality of membranes, wherein each membrane is spaced apart from an adjacent membrane by about 6 mm.

54. The system of claim 47, wherein the collector is exposed to a pressure characteristic of atmospheric pressure at sea level via a passageway.

55. The system of claim 54, wherein the passageway is a breathing tube.

56. The system of claim 55, wherein the breathing tube extends from about the submerged depth to at least a surface of the body of feed water.

57. The system of claim 54, wherein the passageway comprises at least one space between two membranes.

58. The system of claim 47, wherein the collector is a holding tank in fluid communication with air at a surface of the body of feed water.

59. The system of claim 47, further comprising a pump configured to transfer permeate from a first location to a second location.

60. The system of claim 47, further comprising a permeate storage tank at least partially submerged in the body of feed water.

61. The system of claim 60, wherein the permeate storage tank is at least partially submerged and comprises a flexible material that can accommodate filling and discharging of permeate.

62. The system of claim 47, comprising at least one membrane module, wherein the membrane module comprises one or more paired flat sheet membranes sealed at edges to prevent ingress of feed water, wherein outer surfaces of the paired flat sheet membranes are configured to be exposed to feed water, and wherein, in use, permeate can be withdrawn from between the paired membrane sheets through a permeate collection module.

63. The system of claim 47, further comprising an offshore platform from which the membrane module is suspended.

64. The system of claim 47, further comprising a channel configured to transport potable water to shore.

65. A filtration system for producing product water from feed water, the system comprising:
at least one nanofiltration membrane, wherein the membranes is configured to permit passage of water therethrough while restricting passage therethrough of at least one constituent, wherein the membrane is configured to be submerged at a depth in a body of feed water containing the constituents, wherein the depth is at least about 6 meters, wherein a first side of the membrane is configured to be exposed to the feed water at a pressure characteristic of the submerged depth, and wherein a collector on a second side of each of the membrane is configured to be exposed to a pressure characteristic of atmospheric pressure at a surface of the body of feed water, whereby, in use, a pressure differential across the membrane drives a filtration process such that a permeate having a reduced concentration of the constituent is obtained on the second side of the membrane, wherein, the membrane is situated so as to prevent surface tension from inhibiting substantially free flow of feed water across the first side of the membrane.

66. The system of claim 65, wherein the depth is at least about 8 meters.

67. The system of claim 65, wherein the depth is at least about 10 meters.

68. The system of claim 65, wherein the pressure differential between the pressure characteristic of the submerged depth and the pressure characteristic of atmospheric pressure provides substantially all of the force driving the filtration process.

69. The system of claim 65, wherein the filtration process occurs without the influence of a vacuum pump.

70. The system of claim 65, further comprising a positive head pump configured to move permeate from the collector to the surface of the body of feed water.

71. A dual-pass system for desalination of water, the system comprising:
a first pass filtration system, the first pass filtration system comprising at least one first nanofiltration membrane configured to permit passage of water therethrough while restricting passage of one or more dissolved ions therethrough, wherein the first membrane is configured to be submerged in a body of seawater to a depth of at least about 113 meters, wherein a first side of the first membrane is configured to be exposed to the seawater at a pressure characteristic of the submerged depth, and wherein a second side of the first membrane is configured to be exposed to a pressure characteristic of atmospheric pressure at sea level or an elevation higher than sea level, whereby, in use, a pressure differential across the first membrane drives a filtration process such that a permeate of reduced salinity is obtained on the second side of the first membrane, wherein the first membrane is configured such that, in use, at least one of gravity and current effectively removes a higher density concentrate away from the first membrane; and
a second pass filtration system, the second pass filtration system comprising at least one second membrane, wherein the second membrane is a nanofiltration membrane or a reverse osmosis membrane.

72. The system of claim 71, wherein a first side of the second membrane is configured to be exposed to the permeate of reduced salinity, and is configured such that, in use, a pressure differential is applied across the second membrane to drive a filtration process such that a permeate of further reduced salinity is obtained on the second side of the second membrane.

73. The system of claim 71, wherein the first-pass filtration system is configured to be submerged in a body of seawater to a depth of from about 152 meters to about 213 meters, the seawater having a salinity of from about 33,000 to 38,000 ppm.

74. The system of claim 71, comprising a plurality of first nanofiltration membranes, wherein each of the first nanofiltration membranes is spaced apart from an adjacent membrane by about 1 mm or more.

75. The system of claim 71, comprising a plurality of first nanofiltration membranes, wherein each of the first nanofiltration membranes is spaced apart from an adjacent membrane by about 2 mm or more.

76. The system of claim 71, comprising a plurality of first nanofiltration membranes, wherein each of the first nanofiltration membranes is spaced apart from an adjacent membrane by from about 2 mm to about 8 mm.

77. A method for treating water, the method comprising:
submerging a membrane module in a source water to a submerged depth, the membrane module comprising at least one membrane unit, the membrane unit having a first side and a second side, wherein at least a portion of the second side is in fluid communication with a collector channel, and wherein the first side is exposed to the source water at a first pressure, wherein the first pressure is characteristic of the submerged depth;
exposing the collector channel to a second pressure, wherein the second pressure is sufficient to induce permeate to cross from the first side to the second side; and
collecting permeate in the collector system.

78. The method of claim 77, wherein the second pressure is characteristic of atmospheric pressure at a surface of the source water or at an elevation higher than the surface of the source water.

79. The method of claim 77, wherein permeate is induced to cross from the first side to the second side without the use of a vacuum pump.

80. The method of claim 77, wherein the membrane unit comprises at least one nanofiltration membrane.

81. The method of claim 80, wherein the membrane module is submerged to a depth of at least about 6 meters.

82. The method of claim 80, wherein the membrane module is submerged to a depth of at least about 8 meters.

83. The method of claim 80, wherein the membrane module is submerged to a depth of at least about 10 meters.

84. The method of claim 80, wherein the membrane module is submerged to a depth of from about 12 meters to about 18 meters.

85. The method of claim 80, wherein the membrane module is submerged to a depth of at least about 30 meters.

86. The method of claim 80, wherein the membrane module is submerged to a depth of at least about 60 meters.

87. The method of claim 80, wherein the membrane module is submerged to a depth of about 60 meters.

88. The method of claim 80, wherein the membrane module is submerged to a depth of from about 60 meters to about 244 meters.

89. The method of claim 80, wherein the membrane module is submerged to a depth of from about 122 meters to about 152 meters.

90. The method of claim 80, wherein the membrane module is submerged to a depth of from about 152 meters to about 183 meters.

91. The method of claim 77, wherein the membrane unit comprises at least one reverse osmosis membrane.

92. The method of claim 91, wherein the membrane module is submerged to a depth of at least about 190 meters.

93. The method of claim 91, wherein the membrane module is submerged to a depth of at least about 244 meters.

94. The method of claim 91, wherein the membrane module is submerged to a depth of from about 259 meters to about 274 meters.

95. The method of claim 77, wherein the membrane unit comprises at least one ultrafiltration membrane.

96. The method of claim 95, wherein the membrane module is submerged to a depth of at least about 6 meters.

97. The method of claim 95, wherein the membrane module is submerged to a depth of at least about 8 meters.

98. The method of claim 95, wherein the membrane module is submerged to a depth of at least about 10 meters.

99. The method of claim 95, wherein the membrane module is submerged to a depth of from about 12 meters to about 18 meters.

100. The method of claim 95, wherein the membrane module is submerged to a depth of at least about 22 meters.

101. The method of claim 95, wherein the membrane module is submerged to a depth of from about 22 meters to about 60 meters.

102. The method of claim 77, wherein the membrane unit comprises at least one microfiltration membrane.

103. The method of claim 102, wherein the membrane module is submerged to a depth of at least about 6 meters.

104. The method of claim 102, wherein the membrane module is submerged to a depth of at least about 8 meters.

105. The method of claim 102, wherein the membrane module is submerged to a depth of at least about 10 meters.

106. The method of claim 102, wherein the membrane module is submerged to a depth of from about 12 meters to about 18 meters.

107. The method of claim 102, wherein the membrane module is submerged to a depth of at least about 7 meters, and is further configured to substantially avoid entrainment of aquatic life as permeate passes from the first side of the membrane element to the second side of the membrane element.

108. A method for treating water, the method comprising:
exposing at least one membrane situated in a body of water to a hydrostatic pressure characteristic of an immersion depth of the membrane, the membrane having a concentrate side and a permeate side, wherein the permeate side is in fluid communication with a collector;
exposing at least a portion of an interior of the collector to a pressure lower than the hydrostatic pressure, whereby permeate passes from the concentrate side to the permeate side of the membrane; and
collecting permeate from the collector.

109. The method of claim 108, wherein the second pressure is characteristic of atmospheric pressure at a surface of the body of water or at an elevation higher than that of the surface of the water.

110. The method of claim 108, wherein the membrane functions as the collector.

111. A method of treating water, the method comprising:
submerging means for screening out at least one unwanted constituent from a source water, the screening means defining a source water side and a product water side, wherein the source water side is exposed to a hydrostatic pressure of the source water;
exposing the product water side to a low pressure system, the low pressure system having a pressure lower than the hydrostatic pressure, whereby product water passes from the source water side to the product water side; and
collecting the product water.

112. A method of manufacturing a water treatment module, the method comprising:
attaching at least one source water spacer to a first membrane unit, the membrane unit comprising two membrane layers spaced apart by a permeate spacer layer, the first membrane unit having a sealed edge portion and an unsealed edge portion;
attaching a second membrane unit to the source water spacer; and
coupling a collector spacer to the unsealed edge portions of the first membrane unit and the second membrane unit, wherein the collector spacer is configured to form a watertight seal separating a source water side of the first membrane unit and the second membrane unit from a product water side of the first membrane unit and the second membrane unit.

113. A method of transporting water from an offshore collection facility to land, the method comprising:
submerging a collection unit at a first depth in a body of water, wherein at least a portion of the collection unit is exposed to an atmospheric pressure;
providing a passageway in fluid communication with the collection unit, the passageway extending from the collection unit to a location on land, wherein the location on land is at an elevation lower than the first depth.

114. The method of claim 113, wherein the collection unit comprises at least one membrane element, each membrane element having a first side and a second side, wherein the first side is exposed to a pressure characteristic of the body of water at the first depth, and wherein the second side is in fluid communication with a portion of the collection unit exposed to atmospheric pressure.
